(19) United States
(12) Patent Application Publication
(10) Pub. No.: US 2015/0103019 A1
(43) Pub. Date: Apr. 16, 2015

(54) Methods and Devices and Systems for Positioning Input Devices and Creating Control

(71) Applicant: Joshua Michael Young, Manuka (AU)

(72) Inventor: Joshua Michael Young, Manuka (AU)

(21) Appl. No.: 14/396,687

(22) PCT Filed: Apr. 23, 2013
(86) PCT No.: PCT/AU2013/000419

§ 371 Date: Oct. 23, 2014

(30) Foreign Application Priority Data
Apr. 23, 2012 (AU) 2012901581
Apr. 24, 2012 (AU) 2012901605
Jan. 20, 2013 (AU) 2013900181

(51) Int. Cl. G06F 3/041

(52) U.S. Cl. CPC G06F 3/041; G06F 2203/04104
USPC 345/173

(57) ABSTRACT

An interface comprising a structure on which a touch-sensitive unit may be positioned, moved through space in association with a user's hand, and receive touch input from one or more of the digits of said hand.

### CROSS-REFERENCE TO RELATED APPLICATIONS

This application claims priority to Australian Provisional Application No. 2012901581 filed on Apr. 23, 2012, Australian Provisional Application No. 2012901605 filed on Apr. 24, 2012, and Australian Provisional Application No. 2013900181 filed on Jan. 20, 2013. Each of these applications are herein incorporated by reference in their entirety.

This application is also related to Australian Provisional Application No. 2009905136 filed on Oct. 22, 2009, International Application No. PCT/AU2010/0011109 filed on Oct. 22, 2010, Australian Provisional Application No. 2010905630 filed on Dec. 23, 2010, Australian Provisional Application No. 2010905631 filed on Dec. 23, 2010, U.S. Provisional Application No. 61/478,278 filed on Apr. 22, 2011, and International Application No. PCT/AU2011/001341 filed on Oct. 21, 2011. Each of these applications are also herein incorporated by reference in their entirety.

### FIELD

This disclosure generally relates to machine interfaces, and, more particularly, to methods, devices and/or systems for creating control signals in response to a user's actions such as the coordinated or independent movement of one or more of the user's digits (fingers/thumb), hand(s), and/or arm(s). Furthermore, this disclosure generally relates to the attachment or positioning of devices that can generate sad control signals, such that a user can effectively manipulate the generation of said control signals.

### BACKGROUND

There are devices that include the capacity to measure their own motion, orientation, position in space, or combinations thereof. These devices may also include touch-sensitive screens or other touch-sensitive mechanisms that measure a user's touch actions. Such a device possessing sensitivities including touch and motion and/or orientation may be referred to as a touch-sensitive unit Examples of touch-sensitive units include, but are not restricted to, “smartphones” (e.g. the “iphone” and “Samsung Galaxy S”), media players (e.g. the “pod touch” and “Samsung Galaxy Player”), “tabletphones” (e.g. the “Samsung Galaxy Note”), “smartwatches”, and “tablet computers” (e.g. the “ipad” and “Samsung Galaxy Tab”).

When a touch-sensitive unit is grasped by the fingers and/or thumb of a user, the user may move this unit in space and use of the units sad motion, orientation, or position-sensing functions while resisting the physical forces that would otherwise cause the unit to be displaced from the user's hand. However, while performing such grasping actions the user's ability to provide touch-input to the units touch sensitive screen may be reduced.

Accordingly there is a need for improved methods, devices, and/or systems whereby a user may move and/or orient a touch-sensitive unit while also being able to provide effective touch input to sad touch-sensitive unit h a substantially simultaneous manner.

### SUMMARY

Exemplary embodiments relate to machine interfaces and/or methods, devices and/or systems for creating control signals in response to a user's actions. In exemplary embodiments, these actions may include, without limitation, the coordinated or independent movement of one or more of the user's digits (fingers/thumb), hand(s), and/or arm(s). Furthermore, this disclosure generally relates to the attachment or positioning devices that can generate sad control signals, such that a user can manipulate the generation of sad control signals more effectively.

Exemplary embodiments of the methods, devices, and/or systems may be used to control the processing of audio information, visual information, output signals, or combinations thereof.

Exemplary embodiments may consist of an interface that includes a platform on which a device with a touch screen or other touch-sensitive mechanism can be positioned or substantially secured. The touch screen device may include sensors that measure the device's motion, location, orientation or combinations thereof, and will be referred to herein as a “touch-sensitive unit”. Sad platform may either be attached to or gripped by elements of the hand such that the user may provide substantially unimpeded touch input to a touch-sensitive unit via the digits of sad hand (fingers and/or thumb). Said attachment or grip action combined with the form of an interface's components may allow the platform, and the touch-sensitive unit, to remain in a substantially stable position relative to said hand regardless of orientation changes or motion of said hand.

Exemplary embodiments may provide benefit to the user by allowing the motion, location, and/or orientation of a touch-sensitive unit to be manipulated while also providing substantially simultaneous and effective access via the user's fingers and/or thumb to sad touch-sensitive unit's touch screen.

Exemplary embodiments may include software installed on a touch-sensitive unit for processing audio information, visual information, output signals, or a combination thereof and may modulate this processing according to touch screen input, unit motion, unit location, unit orientation, or a combination thereof. This software may allow the configuration of input processing, including the creation of “activation points” on the touch screen which can be used to trigger or otherwise modulate specific events. The number, size, shape, and behavior of these activation points may also be configurable in the software.

In exemplary embodiments, the systems, devices, and methods may be utilized as an input interface for manipulating data, including audio and visual data For example, the activation points on the touch screen of a touch-sensitive unit may be mapped to notes (musical pitches) on a chromatic or diatonic scale. Furthermore, one axis of the orientation of the unit may be mapped to a series of zones that control the octave of a note's pitch, one axis of the orientation of the unit may be used to control gradated pitch, one axis of the orientation of the unit may be used to control one or more sound effects, one axis of the orientation of the unit may be used to control the rate of playback of audio or video samples, one axis of the orientation of the unit may be used to control additional audio or visual parameters, or a combination thereof. Translational and rotational motion as well as position may also be used as forms of control.

Exemplary embodiments may include components that wholly or partially cover the touch screen of a touch-sensitive unit and act to improve the temporal accuracy and/or spatial accuracy of touch input in exemplary embodiments different mechanisms of adjustment may be included, allowing adjustment of the angle of a touch-sensitive unit relative to the hand, the distance of a touch-sensitive unit relative to the hand, the fit of the attachment mechanism to the hand, or a combination thereof.

### DESCRIPTION OF THE DRAWINGS

Exemplary embodiments will now be described, by way of example only, with reference to the accompanying drawings in which:

FIG. 1 illustrates an exemplary embodiment of an interface from a top left perspective;

FIG. 2 illustrates an exemplary embodiment of an interface from a rotated top left perspective;

FIG. 3 illustrates an exemplary embodiment of an interface from a lower rear perspective;

FIG. 4 illustrates an exemplary embodiment of an interface from a lower front perspective;

FIG. 5 illustrates an exemplary embodiment of an interface from a top-down perspective;

FIG. 6 illustrates an exemplary embodiment of an interface from a left-side perspective;

FIG. 7 illustrates an exemplary embodiment of an interface from a top-down perspective;

FIG. 8 illustrates an exemplary embodiment of an interface from a top-down perspective;

FIG. 9A and 9B illustrate an exemplary embodiment of an interface from a left-side perspective;

FIG. 10 illustrates an exemplary embodiment of components involved in achieving audio control functionality;

FIG. 11 illustrates an exemplary embodiment of algorithms involved in manipulating audio and/or visual content;

FIG. 12A illustrates an exemplary embodiment of components involved in achieving gaming functionality;

FIG. 12B illustrates an exemplary embodiment of content involved in achieving gaming functionality.

FIG. 13 illustrates an exemplary embodiment of an interface from a top-down perspective;

FIG. 14 illustrates an exemplary embodiment of an interface from a rotated top left perspective;

FIG. 15 illustrates an exemplary embodiment of an interface from a lower rear perspective;

FIG. 16 illustrates an exemplary embodiment of an interface from a lower front perspective;

FIG. 17 illustrates an exemplary embodiment of an interface from a top-down perspective;

FIG. 18 illustrates an exemplary embodiment of an interface from a top-down perspective;

FIG. 19 illustrates an exemplary embodiment of an interface from a top-down perspective;

FIG. 20 illustrates an exemplary embodiment of an interface from a top-down perspective;

FIG. 21 illustrates an exemplary embodiment of an interface from a top-down perspective;

FIG. 22 illustrates an exemplary embodiment of an interface from a top-down perspective;

FIG. 23 illustrates an exemplary embodiment of an interface from a lower front perspective (rotated); and

FIG. 24 illustrates exemplary uses of exemplary embodiments;

### DESCRIPTION OF EXEMPLARY EMBODIMENTS

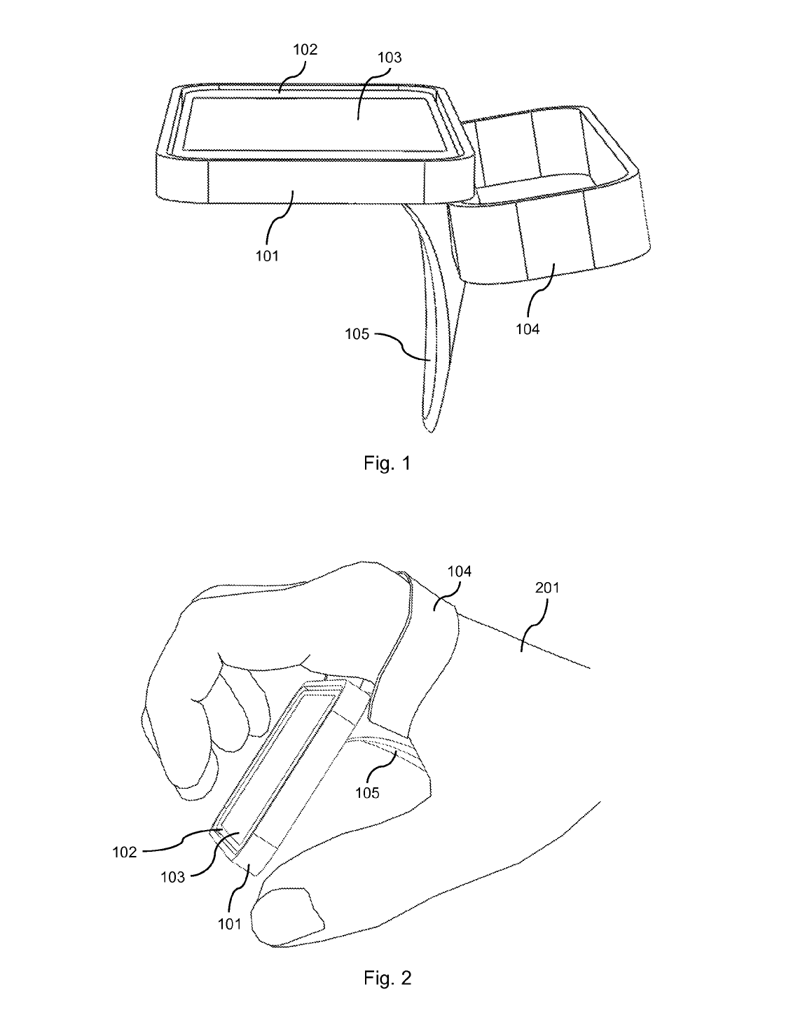

Exemplary embodiments of an interface device are illustrated in FIG. 1 to FIG. 9. These exemplary embodiments are designed to interact with the right hand of the user, and the terms “left” and “rip” used in this description are also defined relative to the user. However, it should be readily understood that the embodiments described herein are not limited to rip hand devices. Methods, devices, and systems deserted herein may also be used with the left hand or with both hands. In exemplary embodiments, the device may be constructed to be used interchangeably with the left and right hands. In this description the term “digit” may refer to either a finger or a thumb.

In general, locations on the human hand and arm mentioned in the following description refer to an anatomical position of the right arm in which the upper arm hangs parallel to the upright body with the elbow bent and with the forearm and hand horizontal to the ground and pointing forwards. This anatomical position will be referred to in this description as the “neutral operating position”.

In this description the term “pitch” may be used in the sense of the pitch of a sound as it is perceived by a listener, rather than as a strict reference to the fundamental frequency of a sound. In the sense used in this description the term pitch is largely synonymous with the musical term “note” (for example, a pitch of C is meant to refer to the note C in any octave).

As illustrated in FIG. 1, exemplary embodiments may include a platform component 101 for the substantially secure retention of a touch-sensitive unit 102. This platform may allow a touch-sensitive unit to be positioned such that its touch screen 103 is facing outwards from the platform. The platform may partially or wholly cover the side of a touch-sensitive unit opposite to the units touch screen. The platform may partially or wholly cover the skies of a touch-sensitive unit perpendicular to the units touch screen, and some or all external ports on a touch-sensitive unit may remain substantially accessible while the unit is within the platform. As those skilled in the art would be aware, the platform component may be constructed wholly or partially with a variety of different materials, including but not restricted to plastic, silicone, rubber, wood, metal, and so forth. Within this description extensive reference will be made to the touch screen of a touch-sensitive unit, however, it should be understood that the invention deserted here may be used in conjunction with touch-sensitive units that use other touch-sensitive mechanisms.

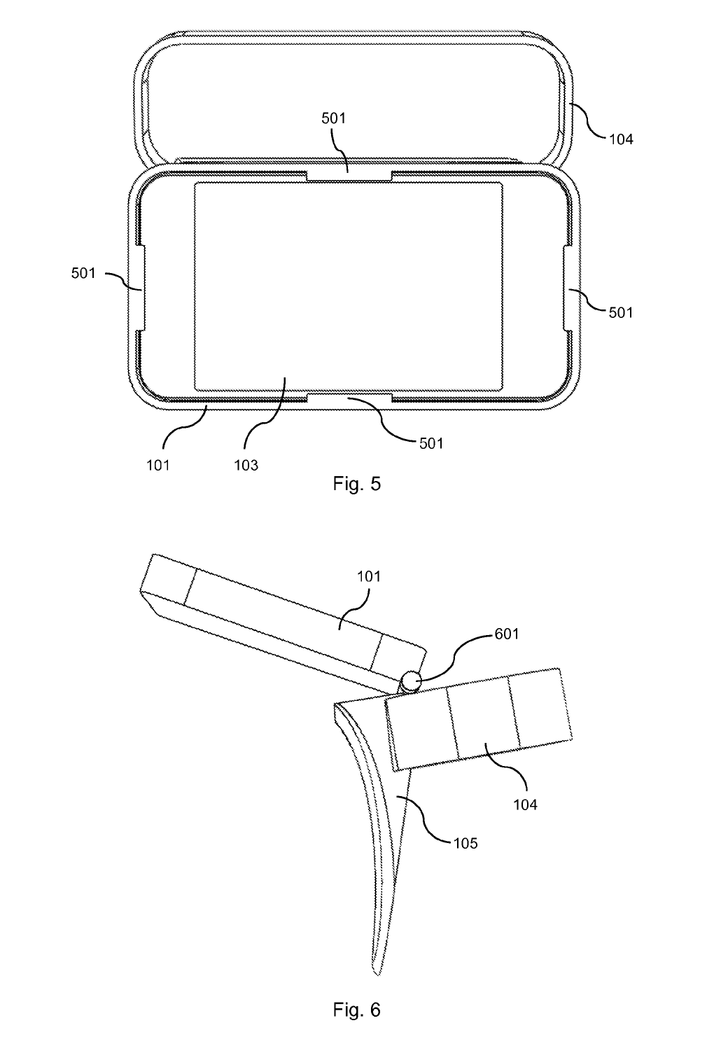

In exemplary embodiments, the platform 101 (see FIG. 1) may include components or characteristics that substantially secure a touch-sensitive unit within the platform. For example, the platform may be partially or wholly constructed from material that is substantially elastic and/or flexible, and this elasticity may act to grip a touch-sensitive unit. As illustrated in FIG. 5, “retainer extensions” 501 may extend from the platform onto the touch screen side of a touch-sensitive unit, thereby substantially obstructing the touch-sensitive unit from exiting the platform. In such exemplary embodiments, insertion and removal of a touch-sensitive unit from the platform and past these extensions 501 may be possible by applying physical force to distort the extensions and/or the platform.

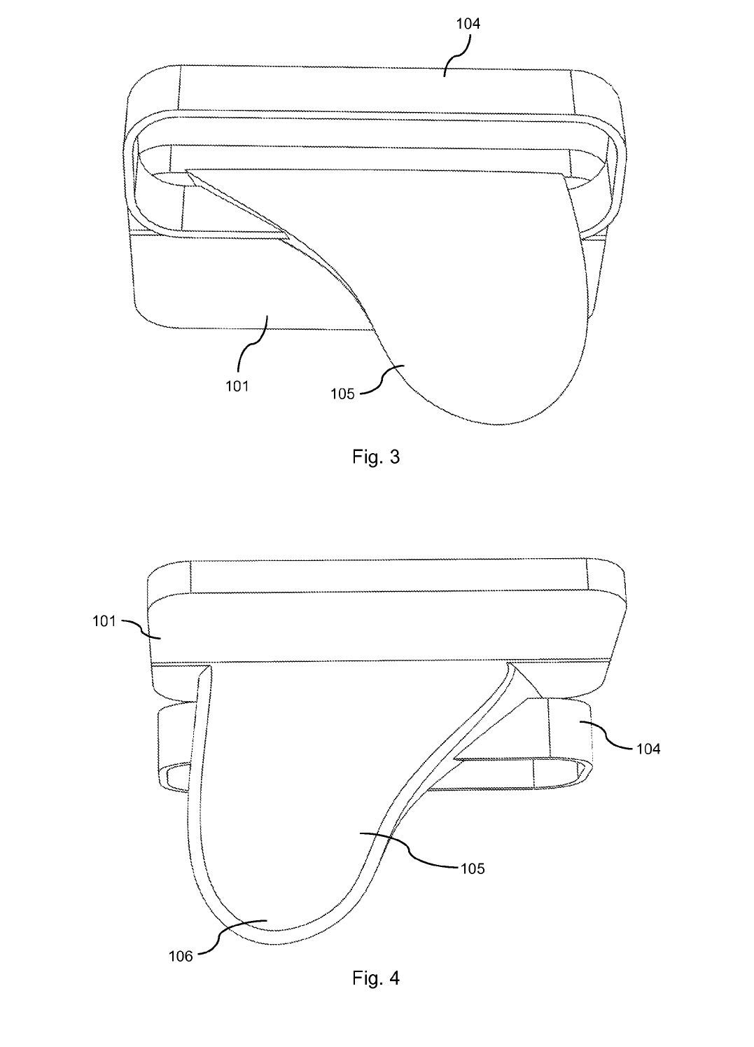

Exemplary embodiments may include a “palm pad” component 105 that extends below the platform 101 (see FIG. 1). As illustrated in FIG. 3 and FIG. 4 this palm pad 105 may be shaped to make contact with specific surface sections of the users palm while in use. This palm pad may prevent the platform and the touch-sensitive unit it supports from being substantially pushed or angled towards the palm while the user is providing touch input to the touch screen 103 via their digits (fingers and/or thumb). As those skilled in the art would be aware, the palm pad component may be constructed wholly or partially with a variety of different materials, including but not restricted to plastic, silicone, rubber, wood, metal, and so forth. The palm pad may include openings within its structure or other materials that may reduce perspiration on the users palm and/or increase the rate of evaporation of perspiration from the users palm.

Exemplary embodiments may include a hand strap 104 similar to that illustrated in FIG. 1. As illustrated in FIG. 2 this had strap 104 may wrap around the back of the users hand 201. As illustrated in FIG. 3 this hand strap 104 may be attached on the left- and right-hand side of the palm pad 105, thereby allowing the strap to attach the palm pad, and thus the rest of the interface, to the user's hand. In exemplary embodiments this hand strap may be flexible and/or elastic, and may also be adjustable in length. As those skilled in the art would be aware, a variety of different mechanisms may be used to achieve this adjustability, including mechanisms like press studs or buckles, etc A hook and bop mechanism may be used, and, in exemplary embodiments, the areas of the hand strap covered by the hook and loop mechanism may be made be sufficiently large to allow the attachment position to be varied while also providing a substantially secure attachment In exemplary embodiments, this variation may allow the tightness of the attachment of the device to the hand to be adjusted, however, additional or alternative tightness adjustment mechanisms may also be used. As those skilled in the art would be aware, the strap component may be constructed wholly or partially with a variety of different materials, including but not restricted to synthetic or natural textiles, elastic, leather, plastic, silicone, rubber, vinyl, and so forth. In exemplary embodiments the palm pad may have a form that allows an interface to be gripped by the thumb ore thumb in combination with the palm (and/or the side of the palm adjacent to the thumb). In such embodiments a hand strap may or may not be included.

As illustrated in FIG. 6, in exemplary embodiments a hinge component 601 may be included to allow the angle formed between the platform and palm pad to be substantially altered. Exemplary embodiments may include one or more reversible mechanisms of substantially stabilizing this angle, until the user chooses to readjust this angle. As would be obvious to those skilled in the art, a variety of stabilizing mechanisms may be used, including but not restricted to a screw within the hinge ads that may substantially prevent hinge movement after the screw has been tightened.

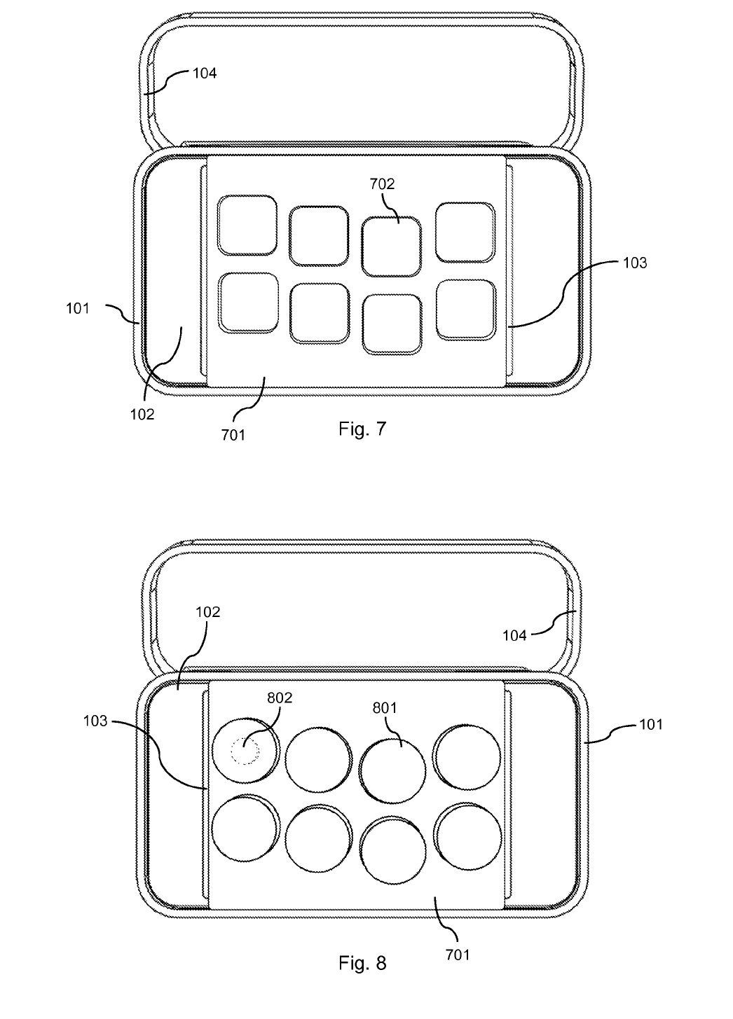

Exemplary embodiments may include an “overlay” component that rests on top of a touch-sensitive units touch screen. As illustrated in FIG. 7 an overlay 701 may include one or more openings 702 in any variety of patterns, for example, eight openings. These openings may allow touch input to occur within their borders (onto the touch screen) while attempted input outside these borders (on to the surface of the overlay) may not be registered. By providing tactile feedback, such an overlay may assist the user in avoiding touching parts of the screen they did not intend to touch, and/or more reliably or precisely touching parts of the touch screen they did intend to touch. Any number of openings or opening shapes may be utilized as part of an overlay. So that the overlay does not substantially lose contact with the touch screen, the overlay may be secured to one or more sides of the platform 101. As would be obvious to those skilled in the art a variety of mechanisms for securing the overlay to the platform may be used, including but not restricted to pins, magnets, clasps, and so forth. As those skilled in the art would be aware, the overlay component itself may be constructed wholly or partially with a variety of different materials, inducing but not restricted to plastic, silicone, rubber, vinyl, wood, metal, and so forth.

In exemplary embodiments an overlay component may incorporate substantially button-like components instead of openings. As illustrated in FIG. 8 such buttons 801 may be distributed across an overlay 701. A variety of button distributions may be implemented, for example, eight buttons. Each button may include, on its internal surface (the surface facing the touch screen), a touch-equivalent component 802. Such a touch-equivalent component may be capable of being registered as touch input when coming into contact with the touch screen. As those skilled in the art would be aware, such an arrangement may operate similar to a membrane button or membrane switch. The button may be partially or wholly constructed from a substantially flexible material. When pressure is applied to the button by a digit (finger or thumb), this flexibility may allow the button to deform and the button's touch-equivalent component 802 to make contact with the touch screen, thereby being registered as a touch. When pressure applied by the digit is removed, the shape memory of the button material may cause the button to resume its original shape and the touch-equivalent component may retract away from the touch screen.

As those skilled in the art would be aware, each button component may be partially or wholly constructed with a variety of different materials, including but not restricted to plastic, silicone, rubber, vinyl, wood, metal, and so forth. Materials for the touch-equivalent component may be chosen depending on the touch screen or other touch-sensitive mechanism with which the touch-equivalent component is intended to interact For example, as would be obvious to those skilled in the art, the touch-equivalent component for a capacitance-based touch screen may be constructed with material that induces a conductance change on the touch screen. In the case of resistive touch screens the touch-equivalent component may be constructed with materials that can be pressed against, and exert sufficient pressure on, the resistive touch screen. Those skilled in the art would be aware that a variety of button mechanisms aside from the membrane type may be used in exemplary embodiments. A benefit of an overlay that includes one or more buttons may be that the user may touch the buttons prior to actuating them, which may allow substantially more temporally-accurate and/or spatially-accurate activations of the touch screen via the user's digits.

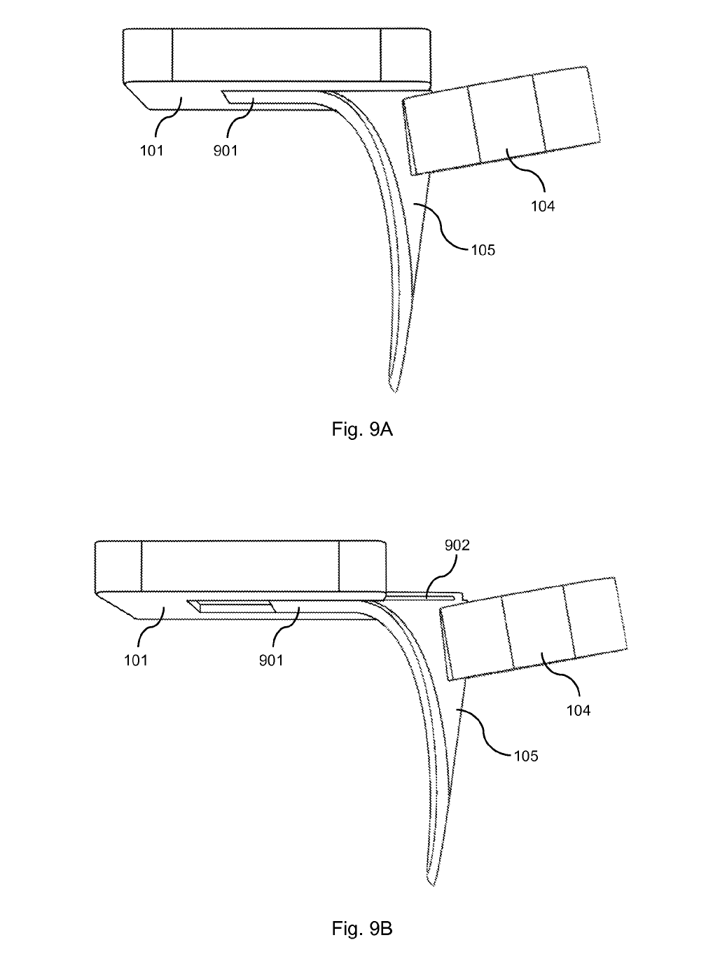

Exemplary embodiments may include one or more mechanisms for adjusting the distance of the platform from the palm pad. As illustrated in FIG. 9A and FIG. 9B, a sliding mechanism may be used to slide the platform 101 along the top section of the palm pad 105. As illustrated in FIG. 9B, a groove 902 running along the sides of the top section of the palm pad may be included. Extensions out of the lower section of the platform that fit within these grooves may also be included to increase the stability of the sliding mechanism. FIG. 9A illustrates an exemplary embodiment with the platform in an adjustment where it is closer to the palm pad. FIG. 9B illustrates an exemplary embodiment with the platform in an adjustment where it is further from the palm pad. Exemplary embodiments may include one or more reversible mechanisms of substantially stabilizing the adjustment position, that may be reversed should the user chose to alter the adjustment. As would be obvious to those skilled in the art a variety of stabilizing mechanisms may be used, including but not restricted to a vertical screw within the front area of the upper sliding section 901 of the palm pad that may substantially hinder position change after tie screw is tightened due to the tip of the screw coming into contact with the lower internal surface of the platform.

In exemplary embodiments a structure connected to the lower area of the palm pad 106 (see FIG. 4) may extend behind the user's wrist in the direction of their elbow (deserted with reference to the neutral operating position defined elsewhere in this description). The weight of the structure section positioned behind the user's wrist in the direction of their elbow may ad as a counterbalance to the weight of an interface and touch-sensitive unit in front of the user's wrist This counterbalance effect may make the interface more comfortable to use, especially during longer periods of use.

Exemplary embodiments may include software that is installed on a touch-sensitive unit. This software may include the capacity to customize zones or points on the touch screen which trigger or otherwise control events. These zones or points will be referred to herein as “activation points”. For example, a series of activation points may be created on the touch screen, with each activation point being associated with a musical sound of a specific pith, such that touch input to an activation point may trigger that musical sound and ceasing said touch input may end the sound. These musical sounds may have a distribution of pitches corresponding to a diatonic or chromatic scale. In exemplary embodiments these activation points may be associated with other entities, such as audio or visual samples. The software may allow the user to alter characteristics of the activation points including their number, layout, and size, and whether additional dimensions may be mapped onto the area within these points for the control of additional parameters. For example, an activation point may have a rectangular form, and where a digit makes contact along the length of this rectangular form may output a different value for a parameter. Examples of the number of activation points a user may elect to use are 4, 6, 7, 8, 12, or 13, but other numbers of activation points may also be chosen. One benefit of this adjustability is that users may be able to create an activation point set up that well-suited to their needs, including the size of their palm and digits. Activation points may have locations, sees, and/or shapes that are substantially collocated with the opening or button locations on an overlay 701 (see FIG. 7). Users may actuate activation points by contacting them with the tips of their digits. In exemplary embodiments where multiple rows of activation points are utilized (similar to opening and button arrangements illustrated in FIG. 7 and FIG. 8) the user may access the different rows of activation points by varying the flexion of their fingers.

In exemplary embodiments the said software may also incorporate one or more data streams from a touch-sensitive units motion, orientation, or position sensors and utilize these data streams in its processes. Audio and/or video output from these applications may be transferred wirelessly or via cable to external equipment to be made audible, viewable, or to be recorded. Other output signals (e.g. MIDI or open sound control messages) may be transferred wirelessly or via cable to external equipment for further processing, transfer, or recording. These various forms of output may also be shared between software applications on a touch-sensitive unit Output from an interface may be made audible, visible, or haptically-perceivable via components included in a touch-sensitive unit, for example; via an external speaker or headphone jack, a display screen, or a vibration motor.

In exemplary embodiments, activation points on a touch-sensitive unit may be operated individually or in combination, thereby creating melody or harmony. In exemplary embodiments, the device may be configured to allow the user to move between octaves by changing the orientation of the device around its lateral axis. Exemplary embodiments may provide for a combination of melodic, harmonic, and/or rhythmic capacities with a motion and/or orientation sensing that is more precise, repeatable, intuitive, convenient, and easier to learn. In exemplary embodiments an interface may provide the user with a variety of options with regard to how angular rate of rotation, orientation (pitch, roll, and yaw), other acceleration data, and/or position data are utilized by software running on the touch-sensitive unit or a connected device. For the sake of simplicity in the following description sensitivities the touch-sensitive unit may include (e.g. touch, motion, orientation, and position sensitivity) as well as its software, processing, and data transfer will be described as a property of an interface as a whole.

In exemplary embodiments these options for sensor data use may include using these data to modulate an interface's processing of input from the activation points. One option, for example, is where the interface responds to activation point input by producing tones or sounds resembling those of a sustained-tone instrument (e.g., cello, violin, saxophone, flute, organ, lead synthesizer sound, etc), and the angular rate of interface rotation around the vertical (yaw) and/or lateral (pitch) axes is used to emulate the effect of varying bowing or blowing intensity on these tones, or changing another equivalent control parameter. In this example the user may be generating changes in the rate of angular rotation in the yaw plane by swinging an interface from side to side (from the neutral operating position), mainly by rotation at the shoulder joint and bending at the elbow. Exemplary embodiments may utilize rates of translational or rotational motion (also termed velocity) to control a variety of audio or visual parameters in addition to those deserted herein.

In exemplary embodiments where the output of one or more rotational sensors is in use, a compound movement of an interface (e.g., involving rotational and translational motion) may provide usable control output as long as that compound movement includes rotation around the axis or axes of measurement Indeed, in exemplary embodiments, when rotation of an exemplary interface around an axis is referred to it is assumed that be user's motion includes, but is not necessarily restricted to, rotational motion around the axis in question. Should the user wish to use a right- and left-handed version of an exemplary interface simultaneously, they may also be provided with a variety of options for utilizing the comparative data of the two interfaces. For example, actuation of a activation point on one interface may select the starting pitch of a tone and actuation of a activation point on the other may select the end pitch of the tone, and reducing the orientation difference between the two interface's (for example, in the lateral axis) may slide the pitch of the tone from the start pitch to the end pitch. Exemplary embodiments may utilize interface-based portamento control and/or vibrato control to modulate the pitch of musical tones, in a manner similar to that deserted elsewhere in this specification. As would be understood by a person skilled in the art, a large variety of additional alternative effects on musical sounds may be configured to be controlled via an interface, and this should not be considered a complete list.

Exemplary embodiments may allow the user to exert “contextual control” via an interface whereby one form of control is used to modulate another form of control. For example, in a configuration where the actuation of at least one activation point elicits the sound of a musical tone, the orientation of an interface around the lateral axis (pitch axis) at the moment of sad actuation may be recorded by the system, and changes in the lateral axis orientation relative to said recorded orientation may be used to control a modulatory sound effect applied to the musical tone. In this example, increasing the lateral axis orientation after activation point actuation (i.e. raising the front of an interface upwards) may be used to increase the rate and/or amplitude of a vibrato effect on the elicited musical tone. However, in a contextual control configuration similar to the example described above a variety of alternative interface outputs (inducing motion, orientation, position, activation point actuation, and so on) may be used to control a variety of other effects.

In another example of contextual control, exemplary embodiments may also provide the user with an “octave selection” option based on interface orientation. This option may control the octave value of the tones triggered by the activation points. In this option the user may choose one of the orientation axes, for example the lateral axis (pitch axis), to be divided into multiple zones. If a total of three angle zones around the lateral axis were chosen (e.g., down, middle, and up) then the lateral axis angle of an interface relative to these zones would determine the octave values of the notes triggered by the activation points. An example of the borders between these three zones might be (assuming 0 degrees as horizontal) −40 degrees and 40 degrees, whereby the down zone is −40 degrees and below, the middle zone is greater than −40 degrees and less than 40 degrees, and the up zone is 40 degrees and above. For each note triggered, three tones in three adjacent octaves may be produced simultaneously, but their respective volumes may be determined by an interface's lateral axis angle relative to the down, middle, and up zones at the time of triggering. For example, actuating a activation point corresponding to the note C while an interface is in the down zone might be set up to trigger the notes C3, C4, and C5, but only C3 would have an audible volume. The user may be given the option of attributing cross-faded volumes to the borders of these zones, such that actuating the C activation point near the border of the down and middle zones would again trigger the C tone h all three octaves but both the C3 and C4 tones would have an audible volume. The user may also be given the option of using this octave selection in a dynamic or constant mode. In the dynamic mode maintaining activation of the C activation point while moving an interface from the down zone to the middle zone would dynamically cross-fade the volumes of the C3 and C4 tones, such that the former would fade and the latter would increase. In the constant mode, tones may retain the zone-based volume level assigned at the time they were triggered, thus actuation of the C activation point in the down zone followed by moving an interface to the middle zone would result in the volume of the C3 tone being maintained at the same level throughout the movement (while possibly being subject to volume-modulation by other aspects of the system). In this example of the constant mode, effectively only one of the notes (in this case C3) in the octave group (in this case C3, C4, and C5) is triggered at a time, and the selection of which note is triggered is dependent on the zone an interface is in at the time of triggering. The processing required to perform the octave selection described above may be performed by a variety of components including software installed on the touch-sensitive unit.

In the above octave selection example an axis of orientation may be used to select from a range of options (a range of octaves in this instance). Similarly, exemplary embodiments may use directions of translational and/or rotational motion to select from different options. For example, zones of interface rotation direction may be configured such that rotating an interface in a specific direction may select a specific option from a range of options. In this example, rotating the interface in a specific direction (e.g. rotating an interface rightwards around the vertical axis) may be used to select a specific frequency of oscillation for a sound effect on a musical tone (e.g. a modulating volume gate or frequency filter, etc). The phase of these oscillations may also be synched to external events, the tempo of a piece of music beep but one example. For example, an oscillation that lasts for one musical bar may be synched to “start” (e.g. cross zero into the positive phase of the oscillation) on the first beat of the bar. As would be understood by those skilled in the art, these forms of “directional control” may be used to control a variety of options and parameters.

In exemplary embodiments, an interface may be a device on which the user may play a computer game, where the user may participate in the game through their operation of the interface. In exemplary embodiments equipment that is designed to generate musical sounds in response to external commands (e.g., MIDI or open sound control messages) may act as a recipient device for signals sent by an interface, with hardware synthesizers being but one example. In exemplary embodiments the recipient device may be a lighting system, whereby a users operation of an interface may control the actions of the lighting system. For example, the recipient device may be a lighting system at a live performance venue. In exemplary embodiments the recipient device may be a system that may be remotely controlled by a users operation of an interface, for example a vehicle or robot

In exemplary embodiments an interface may act as a data-entry device, where the range of different discrete output signals the interface can produce may be mapped to a specific data set (e.g., letters, numbers, eta). In exemplary embodiments the range of different output signals an interface can produce may be expanded beyond what can be achieved by actuating individual activation points by making the events triggered by activation point actuation dependent on the interface's orientation and/or motion (in a similar way to the octave selection option described above). In exemplary embodiments, additional specific events may be triggered through specific combinations of activation point actuation. For example, in the case of an interface with 8 activation points, these points may be assigned event 1, event 2, event 3, and so on through to event 8. However, pairs of points actuated substantially at the same time may be configured to trigger more events beyond the initial 8. Combinations of more than two points may also be employed. In this example the events may be musical tones with specific pitches, or characters from an alphabet, eta Such a “combinatorial configuration” may be utilized for a variety of exemplary embodiments including interfaces with different numbers of activation points and different activation point configurations.

In exemplary embodiments one or more interface points may be assigned a modal role, whereby said modal point primarily modulates the events triggered by other points. Such a “modal configuration” may be utilized for a variety of exemplary embodiments including interfaces with different amounts of points and different point configurations. In exemplary embodiments other interfaces that provide suitable input to the exemplary systems detailed in this description may be used. Appropriate input may include input that can provide one or more discrete input values (for triggering individual pitches or notes, for example) and/or one or more substantially continuous values (e.g., a number that may take values between 0 and 100, and can perform the same role as, for example, data derived from a touch-sensitive unit that measures angular rotation rate or orientation around a vertical axis). For example, a MIDI keyboard equipped with a MIDI control wheel may provide discrete output events via the keyboard keys and substantially continuous values via the MIDI control wheel. In another example, moving or orienting other motion, orientation, and/or position sensitive devices (e.g. a hand-held video game device) may provide one or more substantially continuous values suitable for use in exemplary embodiments. Furthermore, some or all of the system of exemplary embodiments described herein may be implemented on a video game platform (e.g., the Microsoft Xbox, Sony Playstation, or Nintendo Wii, et) or other computer, either in association with, or independent from, the exemplary interfaces described herein.

Exemplary embodiments may involve the manipulation of audio only, while others may involve the manipulation of video only. Possible sources of pa-recorded video include live action video (e.g., a music video), computer-generated video, or animated video. In exemplary embodiments computer graphics may be used in conjunction with or instead of pre-recorded video. In exemplary embodiments some or all the ado may be synthesized in real-time, rather than some or all of the audio relying on pre-made recordings. In exemplary embodiments video and/or audio may be transferred wirelessly or via cable connections to external devices for viewing and/or listening (e.g. television, projection, computer, etc).

In exemplary embodiments that use a music video as raw material, some or all of the components of the video's audio may be configured to be manipulated by the user. In exemplary embodiments, some or all of the elements of a video's visual component also may be configured to be manipulated by the user.

Exemplary embodiments may include the benefit of providing the user with an enhanced experience of engagement with musical audio or visual images or both due to the user's sense of involvement or “agency” in the timing and rate of the aural and visual elements of the embodiment This sense of involvement may be created through a game-type format where the user may trigger and/or control the rate of playback of audio and/or video samples. The user may also control additional modulations of the samples, including the pitch of an audio steam, or the application of effects to the audio and/or video streams. As part of the game the user may be required to trigger particular events within certain time windows, or achieving certain rates of a control signal, or they may be assessed on particular features of their improvisation. Audio and/or visual feedback may be provided to the user as part of playing the game. For example, location and/or specific visual features may indicate activation point actuation timings that may contribute to the controlled audio sample sounding as if it is being played back at the ideal rate.

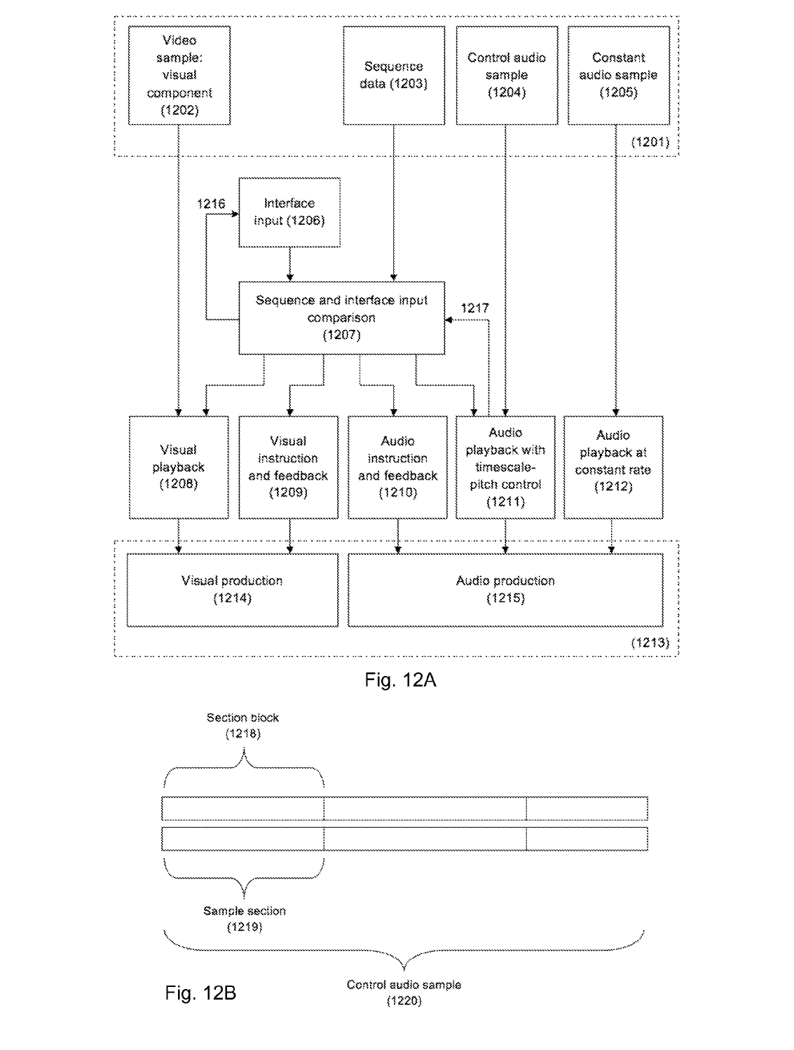

An exemplary embodiment of a game system is illustrated in FIG. 12A The components illustrated in FIG. 12A may be implemented by software or hardware or a combination of both. Some components may be classified as “content” 1201, in that they may be materials that are supplied to an exemplary embodiment for use during its operation. Such content may be “offline” in origin, meaning that the content may be created prior to the user operating the system. Furthermore, the content may be created with or without the involvement of some exemplary component deserted herein. Included in this content may be a video sample 1202, for example, the visual component of a music video. Additional content may include sequence data 1203. Sequence data may describe game elements that are intended to ad n sync with visual and audio samples.

Other examples of content components 1201 may include a “control audio sample” 1204 and a “constant audio sample” 1205. During operation of exemplary embodiments, the control audio sample may have the rate and timing of its playback controlled by the user via an interface, while the constant audio sample may be played back at a normal constant speed. In some exemplary embodiments these samples may be associated, along with the video sample 1202, with the same piece of music. For example the control audio sample may be a vocal track from a piece of music, and the constant audio sample may be the “backing instruments” from that same piece of music. Furthermore, the video sample may be the visual component of a music video made to accompany that same piece of music.

In exemplary embodiments the audio and/or video samples may be divided into “sample sections” 1219, as illustrated in FIG. 12B. In exemplary embodiments where instructive visual feedback is presented to the user these sample sections may be visually represented as “section blocks” 1218. In some exemplary embodiments these sample sections and their corresponding section blocks may be consecutive. In other words, playing through each sample section one after another would advance smoothly through the entire sample 1220. A sample may be divided into any number of section blocks. An example of audio that might be configured for control via an interface is a singer's voice singing a song, and a section block may be set to correspond to one musical bar of that singing. For example, in the case of a song with a time signature of 4/4, one bar would consist of four beats occurring at a rate determined by the tempo of the song (often expressed in beats per minute). A smaller block may be set to correspond to a shorter section, for example, one half of a bar. Since exemplary embodiments may also be configured such that an interface may be used to control video alone or in conjunction with audio, for the purposes of the description below the term “control audio sample” may be considered synonymous with the term “control video sample”.

In an exemplary embodiment illustrated in FIG. 12A another form of input that may be provided to the system originates from the user interactions with an interface 1206. This interface input may include one or more continuous control signals that may direct the timing and rate of visual or audio playback or both, as well as any other feedback elements relating to playback. This interface input may also include discrete control signals capable of controlling a range of individual and independent events. In exemplary embodiments one or more interfaces that are detailed in this description may be employed to provide interface input 1206. In exemplary embodiments the continuous control signals may originate from motion, orientation, and/or position sensing included in an interface, and the discrete control signals may originate from the activation points of an interface. A variety of interfaces aside from exemplary embodiments described here may be used to provide interface input to this system.

The sequence data 1203 and interface input 1206 may be provided to a “comparison component” 1207. This sequence data may specify what and when actions should be performed on an interface by the user, while the interface input may describe what interface actions are actually occurring. Component 1207 may include the “rules” of a game in algorithmic form with allow the sequence data and interface input to be combined and compared, with the results of that comparison to be fed back to the user via subsequent components as visual or aural elements or both. For example, the continuous control signals from an interface may include continuously-updated values that represent rates of some kind and may be “dated” by sequence data. More specifically, if an interface as detailed in this description is acing as the interface for this application, a rate of vertical axis rotation with a directional sign (plus or minus, i.e., clockwise or anticlockwise) may act as a continuous control signal. If rotation occurs at the correct time and in the right direction (as specified by section blocks) the continuous control signals may be allowed to pass on subsequent components in the system. Similarly if an interface as detailed in this description is acting as the interface for this application, activation point actuation that is correctly selected and timed relative to sequence data may be allowed to trigger events in subsequent components in the system, and may also act as an additional required permission for continuous control signals to be passed on to these components. In exemplary embodiments activation point actuation may also be employed to trigger pitch alterations in the control audio sample.

Comparison of sequence data and interface input may also be used by the comparison component 1207 to assess the user's performance, the results of which may be fed back to the user as visual or aural elements or both. In exemplary embodiments where an employed interface has components that may provide visual, aural, and/or haptic feedback to the user 1216, instructions or feedback originating from the comparison component 1207 may be provided to the user via these feedback components 1216.

When permitted by comparison component 1207, the continuous control signal may be passed on to visual and audio playback components 1208 and 1211. These components may be configured to buffer the video sample 1202 and control audio sample 1204 respectively, and may play these samples back at rates and times specified by the comparison component 1207 (through its processing of interface input). The audio playback component 1211 may employ timescale-pitch control methods to allow the rate of playback to be varied without altering the sample's pitch. In embodiments that allow the user to control the pitch of the control audio sample, timescale-pitch control methods may be employed by component 1211 to shift the pith of the control audio sample without affecting the sample's playback rate. Aspects of the directed audio playback performed by component 1211 may be fed back 1217 to comparison component 1207 to contribute to an assessment of the user's performance. These aspects may include the rhythmic or melodic qualities of the control audio sample as directed by the user. Alternatively, in exemplary embodiments, rhythmic and melodic features provided by the control audio sample may be extracted “offline”, included as part of the sequence data 1203, and compared to interface input 1206 to contribute to a performance assessment performed by the comparison component 1207 (without requiring feedback from playback component 1211).

Similar to playback components 1208 and 1211, audio playback component 1212 may be configured to buffer the constant audio sample 1205. However, playback component 1212 may be configured to play back the constant audio sample at a constant late, independent of input from an interface.

In exemplary embodiments, the comparison component 1207 may also pass its output on to a visual instruction and feedback generator 1209. This component may generate visual instructions to be provided to the user as well as feedback on their actions. Comparison component 1207 may also pass its output on to an audio instruction and feedback generator 1210. This component may generate aural instructions to be provided to the user as well as feedback on their actions (e.g., a mistimed activation point actuation may result in the sound effect of a vocalist failing to sing correctly).

As illustrated in FIG. 12A, in an exemplary embodiment various elements may be made perceivable 1213 to one or more users. Visual components 1208 and 1209 may supply video and graphics data to a visual production component 1214 that can make these elements visible (e.g., a TV screen, computer monitor, projected image, etc) or record them for viewing at a later time, or both. Similarly, audio components 1210, 1211, and 1212 may supply audio sample and sound effect data to an audio production component 1215 that can make these elements audile (e.g., speakers, headphones, etc) or record them for listening at a later time, or both. In exemplary embodiments, either or both the visual production component 1214 and the audio production component 1215 may be components on an interface itself (e.g. the touch screen and speaker/headphone jack on a touch-sensitive unit).

In exemplary embodiments that incorporate activation point input, actuating an activation point may cause the pitch of the control audio sample to match a pitch assigned to that activation point. For example, if the control audio sample is of a singer's voice, actuating an activation point may cause the pitch of the singer's voice to be shifted to match the pitch assigned to the actuated activation point. The more activation points and additional methods of pitch selection that an interface possesses the greater the number of possible pitches the user may have to choose from for shifting the pitch of the control audio sample. This pitch controlling function may be of benefit to users who may wait the opportunity to improvise with the melody of the control audio sample or to recreate the original melody under their control. In such exemplary embodiments, visual guidance may be provided to the user to assist them in achieving specific melodies. Some embodiments of this type may also allow the user to create harmonies with the control audio sample by actuating more than one activation point at a time.

In exemplary embodiments the performance of the user playing the game may be assessed and this assessment may be provided to the user as feedback. One example of an assessable aspect of user performance may include the accuracy of timing the beginning of a sample-controlling movement of an interface or, in the case of a section block immediately following another section block, the accuracy of the timing in the change in the direction of movement of the interface between those section blocks.

Characteristics of the rate of movement of an interface may also be assessed by exemplary embodiments, including the consistency of the rate and how dose the rate value is to an ideal value (e.g. the rate that is required to reproduce the control audio sample as it sounds in the original complete sample played at normal speed). Exemplary embodiments may also be configured to identify and assess user-generated rhythmic variations in the playback of the control audio sample. For example, high amplitude transients in the control audio sample may be repositioned (by the user's movements of an interface) to occur at new rhythmically-classifiable timings. When recognizing that these new timings fit into a conventional rhythmic structure (that differs from the audio sample played continuously at the deal rate) exemplary embodiments may be configured to increase the positivity of their assessment of the user's performance.

The accuracy of activation point actuation timing is another example aspect of user performance exemplary embodiments may assess. Another example may be the accuracy with which the user, by actuating the correct activation points at the correct times, reproduces the melody of the original control audio sample. Other embodiments may be configured to use conventional rules of composition to assess a user's improvisation with the pitch of the control audio sample.

In exemplary embodiments it may be desirable to use audio processing methods to produce specific audio effects in response to user actions. For example, an effect may be employed whereby slowing down or speeding up the control audio sample does not alter the control audio sample's pitch. Furthermore, this effect may also allow the control audio sample to be halted entirely, while remaining continuously audile, as if the sound is “frozen” in time.

The speed/pitch audio effects mentioned above are commonly referred to as “audio timescale-pitch modification” or “audio time stretching”. As those skilled in the art would be aware, these techniques include “time domain harmonic scaling” and “phase vocoding”. These techniques can produce audio from an audio track that matches the perceived pitch of that audio track played at normal speed despite the audio track being played through faster or slower relative to normal speed, or in reverse. Furthermore, these techniques allow the audio track to be halted part way through being played, with a constant sound being produced that is representative of the sound at that audio track position when the audio track b being played through at normal speed.

These audio time stretching techniques can be incorporated into the hardware or software of exemplary embodiments by any person skilled in the art. By processing the control audio sample in the manner described above the listener may perceive the sample's sound as having a quality of consistency regardless of how fast or slow the control audio sample is played through, or whether it is played in reverse, or halted altogether. Descried another way, this audio processing contributes to the perception that, within the audio sample, the rate at which events are occurring is being sped up, slowed down, reversed, or halted altogether.

In exemplary embodiments where activation point actuations on an interface are used to control the pitch of a control audio sample (as defined above) the system may be configured to pre-process the control audio sample prior to operation. If the control audio sample is monophonic (for example a human voice) and its pitch varies lithe throughout its duration it may be desirable to tune the entire sample to a single pitch. If the range of pitches within the control audio sample is large it may be desirable instead to tune the sample to a sequence of constant pitches, with each constant pith at a frequency centered on the pitch frequencies it is replacing. If the control audio sample is polyphonic the pitch processing may be configured to make each pitch in the polyphony continuous for the duration of the sample. In each case the processed control audio sample is passed on with data specifying which pitch (or pitches) the sample is tuned to and, it the pitch varies, at which sample time positions the pith changes occur.

In exemplary embodiments that involve manipulation of the pith of a control audio sample, use of the pre-processing step described above may reduce the computational bad of pitch manipulation during operation. The pre-processed control audio sample will have more or completely constant pitch and the pitch value or values will already be known. When a new activation point actuation is received the pitch difference between the current pitch of the processed control audio sample and the desired pitch (or pitches) may be calculated. This pitch difference may then be used to shift the current pith of the audio track to the desired pitch, subject to any pre-set pitch glide effects that may be utilized. Some pitch shifting methods incorporate a technique termed “formant preservation”, which is described in more detail elsewhere in this application. Exemplary embodiments may include formant-preserving pith shifting methods, since these can assist in making shifted pitches sound more “natural” or less “artificial” to a listener. Pitch shifting techniques, including those that incorporate formant preservation, can be incorporated into the hardware or software of exemplary embodiments by persons skilled in the art.

In exemplary embodiments a user may capture their voice or another's vote via one or more microphones and manipulate the vocal sound via an interface in real-time. An example of manipulation may be to alter the pith of the vocal sound. Exemplary embodiments may make audile or record more than one audio stream. For example, one audio stream may be a vocal sound in a non- or partially-manipulated state (which will be referred to as the “source audio stream”), while another may be a duplicate or substantially duplicate manipulated version of the same vocal sound (which may be referred to as the “duplicate audio stream”). If exemplary embodiments of this type use pitch-manipulation of one or more duplicate audio steams, then the source audio stream may act in concert with the duplicate audio stream(s) to create harmonies. In such systems the pitch of a delicate audio stream may be controlled by the user via the activation points on an interface. Additional mechanisms for pitch selection detailed elsewhere in this description may also be employed. Additional sensor data from an interface may also be used to manipulate the audio streams, for example, controlling the volume of a duplicate audio stream. In addition to the human voice, any other form of audio derived from acoustic oscillation or synthesis may act as a source audio stream.

For some audio streams that are monophonic (i.e., consisting of only one pitch at a time), exemplary embodiments may be configured to produce one duplicate audio stream for each actuated activation point In such a configuration each activation point may also specify a pitch or pitch change amount that the duplicate audio stream it elicits should be shifted to or by. This configuration may allow the creation of multi-part harmonies made up of a source audio stream and one or more differently-pitched duplicate audio streams. Other exemplary embodiments may be configured to only make one or more duplicate audio streams audile.

For audio steams that are polyphonic (i.e., consisting of more than one pitch at a time), the system may be configured to produce one duplicate audio stream for each actuated activation point Additionally, in exemplary embodiments, the system may be configured to shift some or all the simultaneous pitches in an audio stream by a single value, with this value being specified by actuation of one or more activation points. For example, if a source audio steam contained two pitches C4 and E4, then selecting a pitch change value of five semitones higher (e.g., via one or more activation points on an interface) may result in a duplicate audio stream having the pitches F4 and A4.

Exemplary embodiments may also be configured to respond to activation point actuation by shifting pitch by an amount relative to the current pitch of an audio stream. This configuration may be referred to as the “relative pitch selection method”. Other exemplary embodiments may be configured to respond to activation point actuation by shifting pitch to a specific absolute pith (that may be referred to as the “target pitch”). This configuration may be referred to as the “absolute pitch selection method”. In either configuration the pitch of the source or duplicate audio streams or both may be detected.

In the relative pitch selection method the pitch shift amount and direction specified by activation point actuation may be referred to as an “interval”. This interval may be compared to the pitch of the duplicate audio stream (prior to pitch shifting) n order to calculate the target pitch (the pith that is to be achieved by the pitch shift). In either pith selection method the pre-shift pith of the duplicate audio steam may be compared to the target pitch in order to calculate the required pitch shift factor. Using either the relative or absolute pitch selection method, more than one activation point may be actuated at one time, thereby producing multiple delicate audio streams with each stream being produced with its own pitch (as specified by the corresponding activation point).

The relative pitch selection method may be especially useful for interfaces that utilize a small number of activation points. For example, the most commonly used pith intervals above the root pith (the pitch the interval is defined against, commonly referred to as the “root note”) are a “3rd”, “4th”, “5th”, “6th”, and “Unison” (same pitch as the root pitch). These intervals are commonly defined relative to diatonic musical “scales” or “keys” (e.g., major or minor scales). In this example each activation point may be configured to elicit a duplicate audio stream shifted by one of these intervals (while a root pitch is produced by the source audio stream). By utilizing the octave selection methods detailed elsewhere in this description, an interface may be able to produce the pitches associated with these intervals in octaves above or below the root pitch. For example, if the intervals are defined relative to C major, the source audio steam is producing the pitch C4, and the user actuates a activation point corresponding to an interval of a 3rd higher, then a duplicate audio stream of the source audio may be produced that has a pitch of E4. However, if the user actuates a activation point corresponding to an interval of a 3rd, while at the same time selecting a lower octave, then a duplicate audio stream of the source audio may be produced that has a pitch of E3. In exemplary embodiments, any combination of intervals may be included to be triggered by any number and arrangement of activation points. Furthermore, multiple activation points may be actuated at one time, thereby producing multiple duplicate audio streams at different pitches.

For exemplary interfaces with more than five activation points the range of intervals available to the user may be larger. For example, an interface with nine activation points may be set to elicit intervals including (relative to the root note) a 6th below, a 5th below, a 4th below, a 3rd below, a unison, a 3rd above, a 4th above, a 5th above, and a 6th above.

For exemplary embodiments that include interfaces with more than five activation points, the use of an absolute pith selection method (see above) may be beneficial. For example, an interface with seven or more activation points may be able to access the pitches of a diatonic scale (e.g., a major or minor scale). In other words, the system may accept a users instruction to set the useable collection of pitches to, for example, the pitches in a C natural minor scale (C, D, Eb, F, G, Ab, and Bb). Any number of different scales with different tonic pitches (first pith of the scale) may be provided for the user to choose from. In this example each of the activation points may be set to elicit one of the pitches in the C natural minor scale. Additionally, by utilizing the octave selection methods detailed elsewhere in this description an interface may also be used to choose which octave each pitch should be produced in. As with the relative pitch selection method, in the absolute pitch selection method multiple activation points may be actuated at one time, thereby producing multiple duplicate audio steams at different pitches.

In conjunction with the absolute pith selection method, exemplary interfaces with more than seven activation points may have a larger number of pitches assigned to them. For example, if the user chose the scale D major, an interface with eight activation points may include the pitches D4, E4, F#4, G4, A4, B4, C#5, and D5. In another example, if the user chose the scale D major, an interface with fifteen activation points may include the pitches D4, E4, F#4, G4, A4, B4, C#5, D5, E5, F#5, G5, A5, B5, C#6, and D6. An example of an arrangement similar to this is shown in the bottom panel of FIG. 12.

Exemplary embodiments that include interfaces with twelve or more activation points may be configured to use the absolute pitch selection method in conjunction with a chromatic arrangement of pitch assignment on the activation points. For example, each of the activation points may be set to elicit one of the pitches C4, Db4, D4, Eb4, E4, F4, Gb4, G4, Ab4, A4, Bb4, or B4. Exemplary interfaces with more than twelve activation points may include a greater range of pitches. For example, an interface with fifteen activation points may use the arrangement C4, Cb4, D4, Eb4, E4, F4, Gb4, G4, Ab4, A4, Bb4, B4, C5, Cb5, and D5. By utilizing the octave selection methods detailed elsewhere in this description, an interface may also be used to choose which octave each pitch should be produced in.

For exemplary embodiments that utilize the absolute method of pitch selection, pitches may be assigned to the activation points, and the system may provide the user with the option of varying the assignment of pitches to the activation points.

Exemplary embodiments may include pith correction on either the source or duplicate audio streams or both. For example, embodiments of this kind may be configured to correct any pith that lies too far between the pitches of a chromatic scale, a correction sometimes referred to as “pith quantization”. Such “off-center” pitches are sometimes described by listeners as being “sharp” or “flat” and may be undesirable in a musical context. In exemplary embodiments, if an audio steam included a tone with a pitch corresponding to a fundamental frequency of 445 Hz, the system may be set up to shift the frequency of this tone to 440 Hz (the frequency of pith A4). This is because 445 Hz is closer to 44-0 Hz than 466 Hz (the frequency of pitch A#4). Because the relationship between a change in pitch frequency and perceived pitch is non-linear, the term “closer” is used here in reference to perceived pith.

Exemplary embodiments may be configured to perform pitch correction on a source audio stream, either before it becomes a duplicate audio steam or before its made audible or recorded. Exemplary embodiments may be configured to perform pitch correction on one or more duplicate audio streams only. Pitch correction of a duplicate audio stream may be desirable if it has Inherited “sharp” or “flat” pitched sounds from its source audio stream. Pitch correction of duplicate audio streams may be integrated into the pitch shifting functionality deserted thus far, whereby the pitch shifting involved in pitch correction and reaching the target pitch is performed h the same processing step. For example, if the source audio stream is producing atone with a pitch corresponding to a frequency of 445 Hz (a “sharp” A4 pitch) and the user directs the system (via an interface) to produce a corresponding delicate audio stream that is shifted up by one octave, pitch correction may be utilized whereby the target pitch frequency is calculated to be 880 Hz rather than 890 Hz (a “sharp” A5 pitch).

Exemplary embodiments may prevent certain pitches from being produced at all, a feature that will be referred to as “pitch scale filtering”. For example, the user may choose to constrain some or all pitches produced by an exemplary embodiment to those found in C major, or D minor, or any other musical scale. This constraint may be especially useful in exemplary embodiments where a relative pitch selection method is used, where each activation point on an interface may be used to elicit a specific interval.

An example of the pitch scale filtering described above would be where the user is provided with a choice of tonic pitch and musical scale,(e.g., major, minor, and so on) and this scale may be used to filter the pitches that can be produced by the filtered audio stream. In such a configuration, pitches that are not present in the chosen scale may be shifted to the closest pitch within that scale. In other words, if the user chose the scale C major, then the set of “permitted” pitches would be C, D, E, F, G, A, and B (in any octave). If an audio steam contained the pitch D# this pith may be shifted to either D or E. As described for the pith correction method above, the direction of the shift may be determined by the frequency of the pitch in the audio stream. For example, if the frequency of the pitch were closer (in the sense of perceived pitch) to the pitch centre of D than E then the audio stream's pitch may be shifted to D.

In exemplary embodiments the pitch scale filtering method may be configured to select target pitches according to intervals specified by a diatonic scale. An example of such a configuration, which may also incorporate the relative pitch selection method, will be described below. First the user may choose to employ a specific musical scale for use with the pitch scale filter, for example, C major (comprising the pitches C, D, E, F, G, A, and B). In this example a source audio stream may be producing a C-pitched tone and the user may have, via interface input, specified that a delicate audio stream should be produced at a pith a “3rd” higher than the tone n the source audio stream. Within the scale of C major a 3rd higher than C is the pitch of E, therefore E would become the target pitch. However, if the pith of the source audio stream changed to D, within the scale of C major a 3rd higher than D is F. Thus F would become the target pitch. Such interval-based rules for selecting target pitches may be used in conjunction with a variety of scale types and with a variety of tonic pitches. Any number of context-specific rules may be included h the pitch scale filter's configuration, allowing it to create musically-appropriate harmonic pitch intervals for a variety of musical scales and for a variety of interval commands elicited by activation points on an interface.

Exemplary embodiments that use a pitch scale filter similar to that deserted above may restrict the types of intervals that can be created by the system. For example, the pitches C and E form a “major 3rd” (four semitones), while the pitches D and F form a “minor 3rd” (three semitones). The system may allow the user to specify that certain intervals, like a minor 3rd, are not permitted. In this example the system may be configured to silence the duplicate audio stream as long as shifting its pitch would cause a minor 3rd interval harmony (D and F) to be created.

Exemplary embodiments may utilize additional measurement data from an interface. For example, an interface may be configured to use measurements from an angular rate sensor to control aspects of manipulation of one or more duplicate audio streams. One example of this manipulation may be to control the volume of one or more duplicate audio streams with the rate of an interface's vertical (yaw) axis rotation (where the users forearm is approximately parallel to the ground plane and the clockwise or anticlockwise movement of the forearm also runs approximately parallel to the ground plane). A compound movement of an interface (e.g., that includes rotational and translational movement) would therefore provide usable control signals as long as that compound movement included vertical axis rotation. In a configuration of this kind, increasing the rate of vertical axis rotation may increase the volume (possibly from a non-audible starting point) of one or more duplicate audio streams.

Exemplary embodiments may utilize other or additional types of interface movement/orientation as control input, and may utilize measurements coming from other sensor types. For example, with the users forearm approximately parallel to the ground, the “roll” angle of an interface (as controlled by, in the neutral operating position, forearm rotation) may be used to control the volume of additional duplicate audio streams. In this example, if the relative pitch selection method (see above) was in use and a duplicate audio stream at an interval of a 3rd above was elicited by the user, then rolling an interface such that the thumb is moved to face upwards may cause an additional duplicate audio stream to be made audible at a pitch that is a 3rd below the pitch of the source audio stream.

Exemplary embodiments may utilize interface-based portamento control and/or vibrato control to modulate the pitch of one or more duplicate audio streams, in a manner similar to that described elsewhere in this specification. Exemplary embodiments may utilize interface-based contextual control and directional control including oscillation rate control effects employing frequency filters and/or volume gates, in a manner similar to that described elsewhere in this specification. As would be understood by a person skilled in the art, a large variety of additional alternative audio effects modulating one or more duplicate audio streams may be configured to be controlled via an interface, and this should not be considered a complete list.

Exemplary embodiments described thus far may utilize real-time pitch detection, that is, the estimation of the pitch or fundamental frequency of an audio signal as it is perceived by a listener. The term “real-time” is used here in the sense that the audio stream processing is taking place approximately as the stream is being recorded or played back. Numerous methods are available for performing real-time pitch detection and can be implemented by persons skilled in the art

Exemplary embodiments described herein may employ real-time pitch shifting. In the case of an absolute pitch selection method, as a new activation point actuation event is received the pitch difference between the corresponding target pitch and pitch of the duplicate audio stream (prior to shifting) may be calculated. This difference may then be used to calculate the required pitch shift factor.

In the case of a relative pitch selection method, as a new activation point actuation event is received the pitch of the duplicate audio steam (prior to shifting) and the selected interval may be used to calculate the target pitch. Alternatively, pith shifting may be achieved by using a fixed shift factor specific to each interval. However, calculating the post-shift pitch may be useful in conjunction with pitch scale filtering for determining if a post-shift pitch would fall within the permitted pitch set This may ensure that only pitches “permitted” by the pitch scale filter may be produced by pitch shifting. After filtering, the resulting target pitch may be used in calculating the required pitch shift factor.

For both the absolute and relative methods of pitch selection, once the pitch shift factor has been finalized it may then be used to shift the current pitch of a duplicate audio stream, subject to any pre-set pitch glide effects that may be employed by an interface. Pitch correction may be performed before, after, or as part of the main pitch shifting process.

Some pitch shifting methods incorporate a technique termed “formant preservation” which is described in more detail elsewhere in this application. Exemplary embodiments may include formant-preserving pitch shifting methods, since these can assist in making shifted pitches sound more “natural” or less “artificial” to a listener. Real-time pitch shifting techniques, including those that incorporate formant preservation, can be incorporated into the hardware or software of exemplary embodiments by persons skilled in the art.

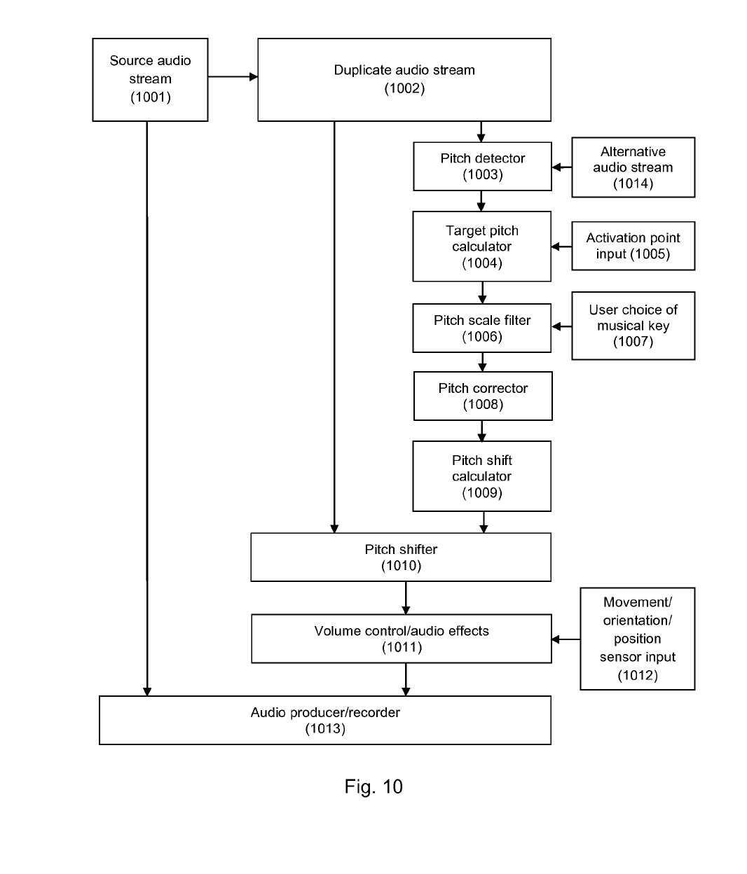

A diagram representing the processing components involved in exemplary embodiments is shown in FIG. 10. As detailed elsewhere in this description, a source audio stream 1001 may be reproduced as a duplicate audio steam 1002. The duplicate audio stream's pitch (or pitches) may be estimated by a pitch detector 1003 and this “pre-shift” pitch estimate may then be passed on to a target pitch calculator 1004. In exemplary embodiments that utilize a relative pitch selection method, input from the activation points 1005 may be combined with the pitch estimate to determine the target pitch. The target pitch (or pitches) and the pre-shift pitch estimate may then be passed on to a pitch scale filter 1006. The activation point input may also include other information relevant to calculating the target pitch, for example, input from an interface's octave selection mechanism (as detailed elsewhere in this description).

Continuing the description of FIG. 10, a pitch scale filter 1006 maybe used to determine if the target pitch belongs to the set of “permitted” pitches (e.g., a scale or key) previously chosen by the user 1007. This choice of musical scale may be made by the user prior to engaging in the audio control process, and may be made via an interface's touch screen or other input method. If the target pitch does belong to the permitted set of pitches it may be passed on unaltered to the next system component (along with the pre-shift pitch estimate). If it does not belong to the set, the pitch scale filter may employ one or more algorithms (see above for description) to decide what the altered target pitch should be. In exemplary embodiments that employ a relative pith selection method, target pitches may be selected according to interval choices specified by a diatonic scale (see above for description). Once finalized, the target pitch may then be passed on to the next system component (along with a pre-shift pitch estimate).

Continuing the description of FIG. 10, a pitch corrector 1008 may be used to identify a “sharp” or “flat” target pitch and correct its value (sometimes referred to as “pitch quantization”). In exemplary embodiments that utilize an absolute pitch selection method the target pitch calculator 1004, the pitch scale filter 1006, or both, may not be employed. Instead, activation point input 1005 and a pre-shift pitch estimate may be provided directly to a pitch column 1008. In this case each activation point may correspond to a specific target pitch (subject to any octave selection mechanism). After any required pith correction the target pitch may be passed on, along with a pre-shift pitch estimate, to a pitch shift calculator 1009. This pitch shift calculator may compare the pre-shift pitch estimate with the target pitch and calculate the shift amount required to make the pitch of the former match that of the latter. This calculated “pitch shift factor” may then be passed on to a pith shifter 1010 component, which then shifts the duplicate audio stream as directed by the pitch shift factor. The duplicate audio stream may then be subjected to additional modulation 1011 (e.g., volume control) as directed by sensor input from an interface 1012. Finally, both source and duplicate audio streams may be made audible (or recorded for future use), subject to any additional effects (e.g., compression, reverb, etc), by an audio producer/recorder component 1013.

In exemplary embodiments of the system illustrated h FIG. 10, the pitch detector 1003 may receive an ado signal via components separate to those that provide an ado signal to the pitch shifter 1010. This alternative audio stream 1014 may originate from the same source (e.g. a singer's voice) but the method of transducing or converting the source into a usable signal may be different For example, the alternative audio stream may be generated through signals obtained from one or more contact microphones (or any other device that measures vibration through direct contact) worn on the singer's body. For example, a contact microphone (also referred as a piezoelectric microphone) may be attached to a singer's neck, chest, or head (e.g. in contact with bone inside the outer ear). These contact microphone signals may undergo amplification, frequency filtering and/or other processing prior to being supplied to the pitch detector 1003. In this exemplary embodiment the pitch detector may not require input from the duplicate audio stream 1002 because the signal for measuring the pitch of the sound source (e.g. a singer's voice) may be supplied by the alternative audio stream 1014. However, while the calculation at stage 1009 of the required pitch shift may be based on signals from the alternative audio stream, the actual audio that would undergo pitch shifting may be that of the duplicate audio stream. The advantage of this exemplary embodiment may be that the alternative audio stream 1014 carries much less signal from sounds extraneous to that of the desired sound source (e.g. unwanted sounds emanating from other musical instruments), due to the low sensitivity of the alternative transduction method (e.g. contact microphone) to airborne vibration. This “cleaner” signal may allow a more accurate measurement of the pitch of the desired sound source by the pitch detector 1003.

Exemplary embodiments may allow the user to exert substantially gradated, as well as discrete, control over the pitches of sounds. The following is a summary of an audio effect that may be achieved by some exemplary embodiments, which may allow the user to trigger specific musical sounds and to control the pitch of these sounds in a gradated manner. The user interface may empty components to measure its orientation and movement within multiple axes in space. Exemplary embodiments may use an interface's orientation or rotation around the vertical (yaw) axis to control sad gradated pitch shifting of a musical sound (however, orientation in either the pitch or roll axes may be used for this purpose instead). An interface may be configured to produce a variety of different musical sound data to be modulated by the pitch shift mechanism. For example, exemplary embodiments may include the capacity to produce musical sounds that have the sound qualities of an electric slide guitar. The activation points may be operated by a user's digits to activate and deactivate said guitar sounds (or “notes”). When two notes are sequentially-triggered, only the first triggered note may produce a sound. However, if the orientation of an interface around the vertical (yaw) axis is changed continuously in either direction (while both of the notes triggered via the interface remain activated), the pitch of the sound may shift gradually from the pitch of the first triggered note to the pitch of the second triggered note. The yaw orientation at the moment the second note was triggered may be termed the “start point” of the total rotation required to reach the second note's pitch (“end point”). The total rotation (in either direction from the start point) around the yaw axis that may be required to reach the pitch of the second note may be configured to be proportional to the pitch difference between the first and second notes. The total required rotation may also be subject to a pre-set value chosen by the user to scale the required rotation to suit their preference.

For simplified use, the user may be able to specify that once the required extent of rotation (to shift from the first to the second note) has been reached the pitch will remain at the pitch of the second note despite continued rotation, unless the user rotates back towards the start point (the yaw orientation at the time the first note was triggered), thereby shifting the pitch back to that of the first note. If the user rotates an interface back from reaching the pitch of the second note (the end point) towards the start point, the system may be configured such that rotating past the start point will not shift the pitch further beyond that of the first triggered note.

The user may be given the option of allowing additional effects to occur once the pitch of the second note is reached. For example, once this end point is reached a tremolo effect that is controlled by the velocity of rotation around the pitch axis may be automatically activated. As would be apparent to a person skilled in the art, a large number of different audio effects may be assigned to the various control signals of an interface, providing the user with a greater range of control over the produced musical sounds.

Once the pitch of the second note is reached the user may un-actuate the first note on the interface (while keeping the second note active) and trigger a third note. Rotation around the yaw axis in either direction may then gradually shift from the pitch of the second note to that of the third note. Obviously this process may be carried on ad infinitum, starting with the second note being un-actuated and a fourth note being triggered and so on. In exemplary embodiments the user may have access to a configuration whereby actuating an activation point on an interface may trigger more than one sound, each with its own pitch. These pitches may have harmonic interval relationships, and rotation around the yaw axis may cause the harmonic set of “fist” pitches to shift in unison to reach a harmonic set of “second” pitches.

In exemplary embodiments where both left- and right-handed interfaces may be used by a user at the same time, the pitch shifting deserted above may be controlled via a comparison of the motion and/or orientation of the two interfaces. For example, actuation of an activation point on one interface may select the first note (start point) and actuation of a point on the other interface may select the second note (end point). If the user begins by holding the two interfaces at different orientations (e.g., on the lateral or vertical axes), then reducing the orientation difference between them may be configured to gradually shift the pitch of the start note to that of the end note. Alternatively, increasing the orientation difference between the two interfaces may be configured to gradually shift the pitch of the start note to that of the end note.

In a similar exemplary embodiment to that deserted above a “portamento effect” may be achieved that does not require more than one activation point to be actuated simultaneously. In this example, the start note and end note of the pitch shift may be continually redefined based on the order in which activation points are actuated. For any activation point actuation that occurs after the first actuation in a session of use, the pitch of the musical sound that is elicited may correspond to the pitch assigned to the previously-actuated activation point By then rotating an interface around its vertical (yaw) axis either left or right the pitch of the elicited sound may gradually shift to the pitch assigned to the currently-actuated activation point, with said pitch shift occurring at a rate proportional to the rate of rotation. To illustrate this with an example, if the activation point 1 is assigned a pitch of C and activation point 2 is assigned a pitch of D (and also assuming that at least one activation point actuation has already occurred), then actuating activation point 1 may elicit a musical sound with the pitch of the previously actuated activation point By then rotating the interface left or right around the vertical axis while maintaining actuation of activation point 1 the pitch of the musical sound may gradually shift to C. Once the pitch of C has been reached the system may be configured to prevent further pitch shifting to or as a consequence of continued vertical axis rotation in the same, or both, directions. Regardless of whether activation point 1 is de-actuated or not, actuating the activation point 2 may then elicit or maintain a musical sound with a pitch of C, and then rotating the interface left or right around the vertical axis, wile maintaining actuation of activation point 2, the pitch of the musical sound may gradually shift to D. This process may be continued indefinitely, allowing the user to play musical sounds with a portamento effect In this exemplary embodiment the system may also be configured to modulate the activation and/or speed of such a portamento effect via one or more oilier control parameters. For example, rotating an interface beyond a certain angle around the longitudinal (roll) axis may activate the portamento effect, and rotating beyond this angle may modulate the proportionality between the rate of rotation around the vertical (yaw) axis and the rate of the pitch slide (e.g. rotating further beyond the roll axis threshold may decrease the rate of the pith slide relative to the vertical axis rotation rate).

Exemplary embodiments described herein may employ real-time pitch shifting. The method by which pitch shifting is achieved may depend of the nature of the audio to be shifted. For example, I the audio is the product of hardware or software synthesis, pitch shifting may be achieved by changing actual synthesis parameters (i.e., whereby an interface is used to control the pitch or pitches at which the audio is synthesized in an ongoing process). In another example, if the audio is derived from recorded audio samples then real-time pith shifting methods may be employed. Some pitch shifting methods, including those that employ “formant preservation”, are detailed elsewhere in this description, and can be incorporated into the hardware or software of exemplary embodiments by persons skilled in the art

In exemplary embodiments the orientation, motion, or position of an interface may be used to control other aspects of sound in addition to pith. For example, orientation or motion around the yaw, pitch, or roll axes may be assigned to modulatory sound effects. The velocity of rotation around the yaw axis, for example, may be assigned to modulate the musical sound with a “wah-wah” effect, similar to the effects processing that takes place in “wah-wah” effects pedals (controlled by motion of the player's foot) used to process electric guitar signals. In this example, the larger the rotation velocity the stronger the wah-wah effect may become.

Exemplary embodiments may allow the user to control recorded or synthesized audio; or the visual component of recorded video or synthesized visual data; or both. An interface may perform operations on audio and/or video samples in response to input from the interface's sensors and produce audio and/or video, or pass on the processed information to an audio/visual production device. The audio/visual production device may make the audio and/or visual video information perceivable to the user and/or their audience via conventional methods, or word this information for later use. Methods for presenting the video information may include a television, or computer screen, or light projector, etc Methods for presenting the audio information may include audio speakers, or headphones, etc. The interface may also possess the capacity to raceme commands from the user that modify its overall operation, providing the option to turn a specific modulatory sound effect on or off, for example.

The following illustrates an audio/visual effect achieved by exemplary embodiments. In exemplary embodiments an interface's orientation around the yaw axis (or “Vertical axis”) may be used to control a video sample's “track position” (however, orientation in either the pitch or roll axes may be used for this purpose instead). The term “track position” refers the part or point in a sample that is currently being made audile or “played” and for the visual and audio components of a video sample a track position value may refer to a matching time position in the two components. In the yaw control example, by moving between two pre-selected limits within the yaw rotation range of the interface, the video track position may be progressed gradually from beginning to end for the visual and/or audio components of the video. For example, if a video sample has 25 frames per second with a duration of 6 seconds, it will contain 150 frames in total. If the interface's control range for yaw rotation is pre-set by the user to be north to north-east, then rotating the interface from north to north-east may gradually switch through the video frames 0 to 150 (i.e., from 0 seconds to 6 seconds). Conversely, rotating the interface from north-east to north may gradually switch through the video frames 150 to 0. Thus the user may choose to move in either direction through the video and at any rate. This interface-based control means they may also pause at any frame within the video, and change direction of movement through the video at any frame. The audio component of a video sample may also have its playback controlled in the same way, in sync with the visual component In the example above, the system may be configured such that moving beyond the two pre-selected limits within the yaw rotation range of the interface from north towards north-west or from north-east towards east) may have no further effect on the visual and audio components of the video. Exemplary embodiments that use an interface's orientation around the yaw axis to control a video sample's track position may do so using measurements from one or more angular rate sensors or one or more magnetic field sensors or a combination of the measurements from the Mo sensor types. In exemplary embodiments where one or more angular rate sensors are used in the absence of magnetic field sensing, track position control may be based on angular distance travelled rather than estimating absolute yaw values (e.g., north, south, etc). In other words, estimates of relative yaw orientation may be used. In exemplary embodiments angular rate and magnetic field sensing estimates of absolute yaw orientation may be used.

Exemplary embodiments may empty audio processing methods that achieve audio that is substantially pitch-constant and continuously-audible regardless of the rate (from zero up) at which the audio track is played through. The usefulness of such an outcome is as follows: The visual component of a video sample, in comparison to an audio component, may remain relatively perceptually-consistent to an observer regardless of the rate at which the video is played through. Halting progress at a particular track position may render the image motionless, and this image may be perceived to have a consistency with the moving images that appeared when the video was being played through (either backwards or forwards). The audio component of the video (termed “audio track”), however, may become far less perceptually-consistent when the rate at which the video is played through changes from normal speed. First and foremost, audio tracks require berg “played though” (i.e., progressed either forwards or backwards) to allow the modulating pressure waves that are perceived as audible sound to be produced at all. In addition, the rate at which an audio track is played through may also affect the perceived pitch of the audio. Techniques for overcoming the dependence of audibility and pitch on audio playback rate are described below.

Audio effects of pitch-constancy and continuous-audibility are often described as “audio timescale-pitch modification” or “audio time stretching”. As would be known by those skilled in the art, techniques for achieving these effects include “time domain harmonic scaling” and “phase vocoding”. These techniques can produce audio that matches the pitch (sound frequency) of an audio track played at normal speed despite the audio track being played through faster or slower relative to normal speed, and/or in reverse. These techniques may also be used to shift the pitch (or pitches) of an audio track by a chosen amount Furthermore, these techniques may allow an audio track to be halted part way through being played, with a constant sound being produced that is representative of the sound at that track position when the audio tack is being played through at normal speed. Pitch shifting methods may incorporate a technique termed “formant preservation”. Formants are prominent frequency regions produced by the resonances in an instrument or vocal tract structure (or synthesis equivalent) that has a strong influence on the timbre of its sound. If the pitch of an audio track is shifted, formant frequencies will also be shifted thereby producing an altered quality of sound that a listener may consider very different from the original quality of sound. For the audio timescale-pitch modification techniques mentioned above, corresponding methods are available for changing the formants to compensate for the side effects of the pitch shifting and thereby “preserve” the formants. Exemplary embodiments may include formant-preserving methods as part of their audio timescale-pitch modification. Audio timescale-pitch modification may be implemented in hardware and/or software by persons skilled in the art. In exemplary embodiments the audio timescale-pitch modification may be performed by interface components.

By processing the audio tack of a video using timescale-pitch modification a listener may perceive the audio component of the video as having a quality of consistency (as possessed intrinsically by the visual component) despite changes in the rate or video playback, or whether it is played in reverse, or haled altogether. Described another way, this audio processing may contribute to the perception that, within the events of the video, time is being sped up, sowed down, reversed, or halted altogether. In the subsequent description the audio timescale-pitch modification will be referred to as the “time stretch algorithm”.

In exemplary embodiments an interface may also provide a user with the opportunity to control when they would like the audio track of the video sample to be made audible and the pith at With they would like this audio to be made audible. For example, if the employed interface includes one or more activation points, exemplary embodiments may be configured such that the ado of the video may only be audible when one or more activation points are actuated. The pitch (or pitches) of the ado may be specified by the user's choice of which activation points to actuate. Thus, while simultaneously controlling the rate (from zero up) and direction the visual and/or audio components of the video are played through, the user may also be given control over when the audio track of the video is audible and at what pitch. This may allow, for example, the user to create melodies using the sound from the video's audio track. Furthermore, exemplary embodiments may allow more than one stream of audio to be activated at one time and at different pitches. In this configuration the user may actuate more than one activation point at a time, thereby initiating multiple streams of the audio track to be produced at the pitches specified by the actuated activation points. This feature may allow, for example, the user to create pitch harmonies.

By way of example, if a video sample used with an exemplary embodiment is of an individual singing one or more words, the user may be able to control the rate and direction in which those words are sung. Using the example control parameters described above, rotating an interface from north to north-east (with the audio activated) may produce synchronized visual and audio video components of said individual singing the phrase at a rate proportional to the speed of the rotation from north to north-east. Conversely, rotating from north-east to north may produce synchronized visual and audio video components of said individual singing the phrase backwards at a rate proportional to the speed of the rotation from north-east to north. The user may also be able to pause at any track position, during a vowel sound for example, and a sound that is representative of the vowel at that track position may continue to be produced (along with the halted visual image at that track position). In exemplary embodiments that employ an interface that can initiate audio streams (e.g., via one or more activation points) the user may have control over when the audio track is audible (i.e.., when at least one audio stream is active). In exemplary embodiments that employ an interface that can specify the pitch of initiated audio streams (e.g., via one or more activation points) the user may have control the pitch (or pitches) that this audio is played at. In a “singer” video example, these pitch and track position controls provided by an interface may contribute to the perception that the user is controlling (in terms of phrasing and pitch) how the individual in the video is singing the phrase. Of course, any video material may be used by exemplary embodiments to create interesting visual and audio effects using methods similar to those described above.

In exemplary embodiments the user may also be given the opportunity to pre-set a “pitch glide” value that may modulate the pitch of audio streams initiated via an interface. For example, if an audio stream is triggered soon after a previously triggered audio stream has been deactivated (or, if only one audio stream is permitted at a time, prior to deactivation), the pitch of the newly-triggered audio stream may shift (either up or down) from the pitch of the previous audio stream to the designated pitch of the newly-triggered audio stream. By choosing the pitch glide value the user may determine over what duration this shift takes place. In exemplary embodiments the user may also be given the opportunity to pie-set the “attack” and/or “decay” aspects of the audio stream triggering, whereby the user may choose how rapidly the audio volume rises after triggering (attack) and/or how rapidly the audio volume diminishes after an audio stream is deactivated (decay).

In exemplary embodiments a variety of additional effects may be configured to be controlled via data generated from an interface. For example, a tremolo effect applied to an audio steam may be configured to be controlled by the rotational velocity of an interface around its lateral axis (i.e., the “pitch” angle of the interface). As another example, the brightness of the video image may be configured to be reduced while no audio streams are active. As an additional example, the volume of the audio may be configured to be reduced when the video is being played in a reverse direction, as opposed to when it is being played in a forward direction. Alternatively, the volume of the audio may be configured to be controlled by an axis of rotation on an interface, for example, the longitudinal axis (i.e., the “roll” angle of the interface). Exemplary embodiments may utilize interface-based portamento control and/or vibrato control to modulate the pitch of the audio track of a video sample in a manner similar to that described elsewhere in this specification. Exemplary embodiments may utilize interface-based contextual control and directional control including oscillation rate control effects employing frequency filters and/or volume gates, in a manner similar to that described elsewhere in this specification. As would be understood by a person skilled in the art, a large variety of additional alternative audio and visual effects may be configured to be controlled via an interface, and this should not be considered a complete list

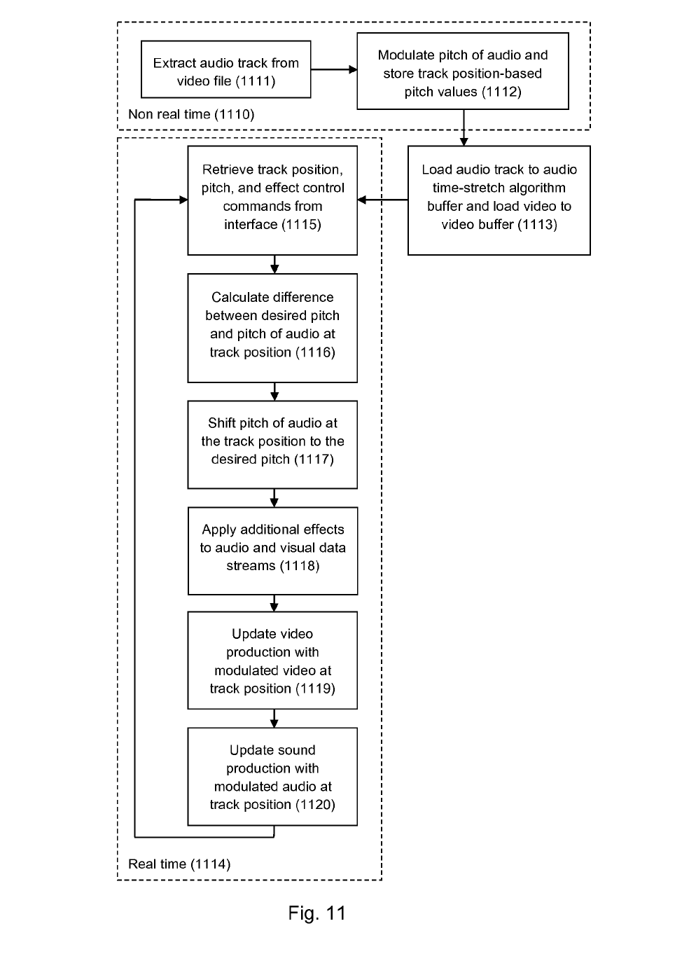

Exemplary embodiments may execute an algorithm as described in the following text and in FIG. 11. This algorithm may be performed by components on an interface. Two preliminary procedures 1110 (see FIG. 11) may be performed prior to initiating an ongoing real-time procedure 1114. These steps may include extracting an audio track from a video sample 1111 and modifying the pitch of this audio track 1112. To simplify processing in the real-time procedure the pitch of the audio track may be modified such that its pitch is set to a single pitch for the duration of the audio tack, or to multiple consecutive constant pitches that change at defined track positions. If the audio is monophonic (for example a human voce) and its pitch varies little during the audio track, it may be desirable to tune the entire sample to a single pitch. If the pitch varies significantly it may be desirable instead to tune the audio track to multiple consecutive pitches. If the audio tack is polyphonic the pitch processing may be configured to make each pitch in the polyphony continuous for the duration of the audio track. In each case the processed audio sample may be passed on with data specifying which pitch (or pitches) the audio track is tuned to and, if the pith varies, at which track positions the pitch changes occur. Numerous methods are available for performing pitch detection including those that analyze audio signals in the frequency- or time-domain, and can be implemented by persons skilled in the art

As shown in FIG. 11 the next step 1113 in the algorithm may be to load the pitch shifted audio track into a time-stretch algorithm buffer (along with the audio racks pitch info) and bad the visual component of the video sample into the video buffer. In exemplary embodiments the triggered audio streams may be the only audible sound produced by the system, and the original audio track in the video sample may not be made audible. In the real-time procedure 1114 the first performed step may be to retrieve the current control commands from an interface 1115. These commands may include updates on audio stream activation, pitch selection, track position, and additional effects. Due to processing in step 1112, the pitch or pitches of the pre-processed audio track may be known for some or all track positions. If a new audio stream activation command was received in step 1115, then the pitch difference between the known current pitch of the audio track and the pitch (or pitches) specified by the interface may be calculated 1116. This pitch difference may then be used to shift the current pitch of the audio track to the desired pitch 1117, potentially subject to any pre-set pitch glide effect As a consequence of the time-stretch algorithm's processing, even if the user pauses at a specific track position, triggering an audio stream via the user interface may produce a sound that is “representative” of the sound at that track position substantially similar to the sound of the audio tack at that position when it is being played through at normal speed, aside from a chosen shift in pitch).

In exemplary embodiments the next step in the real-time procedure 1114 (see FIG. 11) may be to apply additional effects to the current audio and visual video data 1118 in accordance with the current commands received from the user interface in step 1115. In this step the pre-set rise or decay in volume of alive or recently deactivated audio streams may be taken into account when calculating the required audio volume level (or levels in the case of simultaneously active audio streams). Finally the updated visual and audio video data may be made audible/visible on the interface or transferred to an external audio/visual production device (steps 1119 and 1120).

In exemplary embodiments, input to an interface may be used to rapidly select between individual audio or video samples, and/or select between positions within an audio or video sample. For example, rotation of an interface around its vertical axis may be configured to advance (either forward or backwards) through a sample's duration and the activation points may allow the user to select which sample is to undergo said advancement. In this example the activation point 1 may be configured to select audio sample A, the activation point 2 to select audio sample B, the activation point 3 to select audio sample C, and so on. In this example the beginning point of advancement for a sample may reset to the beginning of the sample each time its corresponding activation point is actuated. Rotating an interface either left or right around the vertical axis may be configured to cause the audio sample to advance forwards through the sample's duration. A variety of other configurations may be used including rightwards rotation advancing the sample forwards, and leftwards rotation advancing the sample backwards. Furthermore, other axes of rotational or translational motion may be used to control sample advancement In exemplary embodiments the rate of advancement may be proportional to the rate of motion, whereby the perceived pitch of an audio sample may be lower it the motion were slower and higher if the motion were faster. In the case of video samples the perceived pace of events within a video sample may be slower if the motion were slower and vice versa Exemplary embodiments of the kinds deserted above may allow the user to produce audio and visual effects similar to “turntabilism” hardware or software (e.g. record turntables or “Serato” DJ software), but with the advantages of combining rapid sample selection and advancement into a single interface that can be operated with one hand and has strong bye performance appeal.

Exemplary embodiments may utilize interface-based contextual control and directional control effects to modulate selected samples, including oscillation rate-control effects employing frequency filters and/or volume gates, in a manner similar to that deserted elsewhere in this specification. As would be understood by persons skilled in the art, a large variety of additional alternative effects for modulating selected samples may be configured to be controlled via an interface, and this should not be considered a complete list

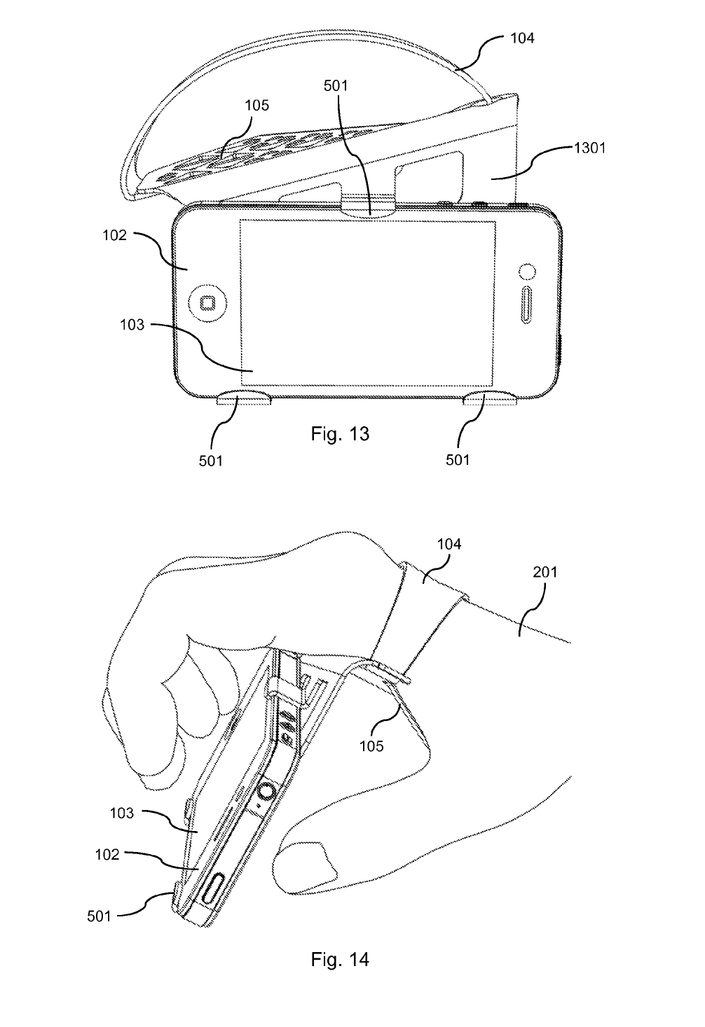

Exemplary embodiments of an interface device are illustrated in FIG. 13 to FIG. 21. These exemplary embodiments are designed to interact with the right hand of the user, and the terms “left” and “right” used in this description are also defined relative to the user. However, it should be readily understood that the embodiments described herein are not limited to right hand devices. Methods, devices, and systems deserted herein may also be used with the left hand or with both hands. In exemplary embodiments, the device may be constructed to be used interchangeably with the left and right hands. In this description the term “digit” may refer to either a finger or a thumb.

As illustrated in FIG. 13, exemplary embodiments may include a platform component 1301 for the substantially secure retention of a touch-sensitive unit 102. This platform may allow a touch-sensitive unit to be positioned such that a touch screen 103 located on its surface is facing outwards from the platform. The platform may partially or wholly cover the side of a touch-sensitive unit opposite to the units touch screen. The platform may partially or molly cover the sides of a touch-sensitive unit perpendicular to the unit's touch screen, and some or all external ports on a touch-sensitive unit may remain substantially accessible while the unit is within the platform. As those skilled in the art would be aware, the platform component may be constructed wholly or partially with a variety of different materials, including but not restricted to plastic, silicone, rubber, wood, metal, and so forth. Within this description extensive reference will be made to the touch screen of a touch-sensitive unit, however, it should be understood that the invention described here may be used in conjunction with touch-sensitive units that use other touch-sensitive mechanisms instead of touch screens.

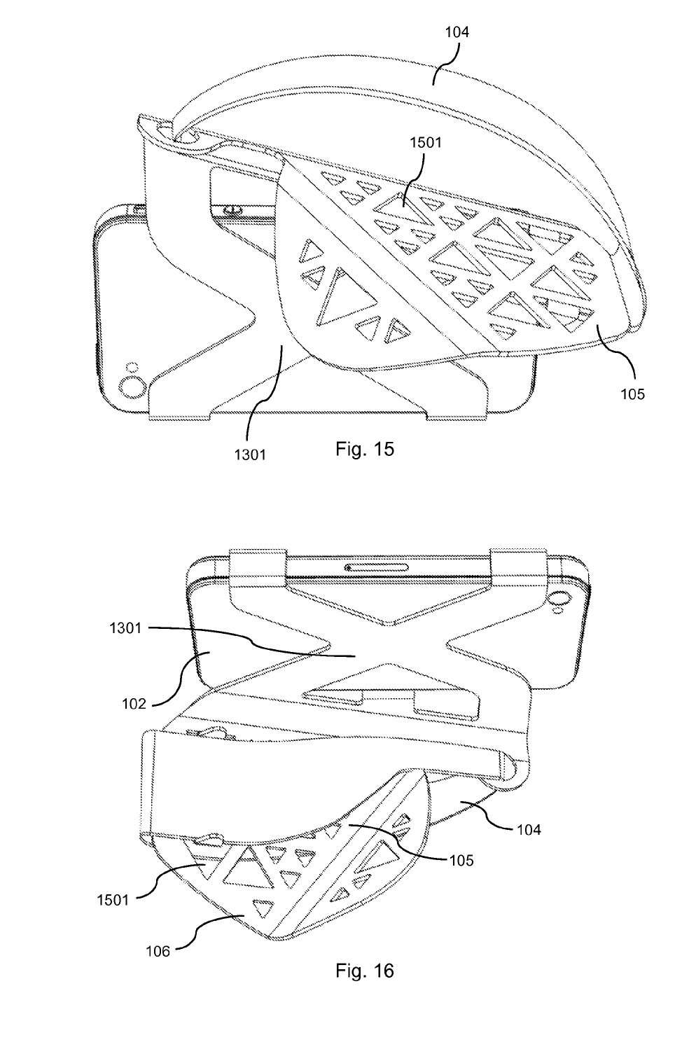

In exemplary embodiments, the platform 1301 (see FIG. 13) may include components or characteristics that substantially secure a touch-sensitive unit within the platform. For example, the platform may be partially or wholly constructed from material that is substantially elastic and/or flexible, and the elasticity may act to grip a touch-sensitive unit. As illustrated in FIG. 13 and FIG. 14, “retainer extensions” 501 may extend from the platform onto the touch screen side of a touch-sensitive unit, thereby substantially preventing the touch sensitive unit from exiting the platform. In such exemplary embodiments, insertion and removal of a touch-sensitive unit from the platform and past these extensions 501 may be possible by applying physical force to distort the extensions and/or the platform, or by inserting the touch-sensitive unit between the top face of the platform and the retainer extensions and sliding the touch-sensitive unit into position. As illustrated in FIG. 13, FIG. 15, and FIG. 16 the platform may have a structure that is sufficient for supporting the retainer extensions only, while lacking areas of structure that are not required for this supporting function. The benefits of this reduced structure may be a reduction in weight.

Exemplary embodiments may include a “palm pad” component 105 that extends from the platform 1301 (see FIG. 13). As illustrated in FIG. 15 and FIG. 16 this palm pad 105 may be shaped to make contact with specific surface sections of the users palm while in use. This palm pad may prevent the platform and the touch-sensitive unit it supports from being substantially pushed or angled towards the palm while the user is providing touch input to the touch screen 103 via their digits (fingers and/or thumb). As illustrated in FIG. 13, FIG. 14, and FIG. 15 the platform 1301 and palm pad 105 may be fixed relative to each other such that, while in the neutral operating position defined elsewhere in this description, the lowest (long) edge of the touch-sensitive unit may be substantially parallel relative to the ground while the plane of the users palm is substantially oriented towards the users body rather than directly at the ground. One benefit of this relative positioning of the platform and the palm pad is that, while in the neutral operating position, the user may exert less muscular effort when orienting the lower (long) edge of the touch-sensitive unit to be substantially parallel relative to the ground. As those skilled in the art would be aware, the palm pad component may be constructed wholly or partially with a variety of different materials, inducing but not restricted to plastic, silicone, rubber, wood, metal, and so forth. As illustrated in FIG. 15 the palm pad may include openings 1501 within its structure or other materials that may reduce perspiration on the users palm and/or increase the rate of evaporation of perspiration from the users palm.

Exemplary embodiments may include a hand strap 104 similar to that illustrated in FIG. 13. As illustrated in FIG. 14 this hand strap 104 may wrap around the back of the users hand 201. As illustrated in FIG. 15 and FIG. 16 this hand strap 104 may be attached on the left- and/or right-hand side (or underside) of the palm pad 105, thereby enabling the strap to attach the palm pad (and thus the rest of the interface) to the users hand. As illustrated in FIG. 14 and FIG. 16 the strap and/or attachment site on the thumb side of the interface may be of less width relative to the strap and/or attachment site on the other side. A benefit of this reduced width around the thumb area may be a more comfortable and ergonomic fit for the users hand. In exemplary embodiments this hand strap may be flexile and/or elastic, and may also be adjustable in length. As those skilled in the art would be aware, a variety of different mechanisms may be used to achieve this adjustability, including mechanisms like press studs or buckles, etc A hook and bop mechanism may be used, and, in exemplary embodiments, the areas of the hand strap covered by the hook and bop mechanism may be made be sufficiently large to allow the attachment position to be varied while also providing a substantially secure attachment In exemplary embodiments, this variation may allow the tightness of the attachment of the device to the hand to be adjusted, however, additional or alternative tightness adjustment mechanisms may also be used. As those skilled in the art would be aware, the strap component may be constructed wholly or partially with a variety of different materials, including but not restricted to synthetic or natural textiles, elastic, leather, plastic, silicone, rubber, vinyl, and so forth. In exemplary embodiments the palm pad may have a form that allows an interface to be gripped by the thumb or the thumb in combination with the palm (and/or the side of the hand adjacent to the thumb). In such embodiments a hand strap may or may not be included.

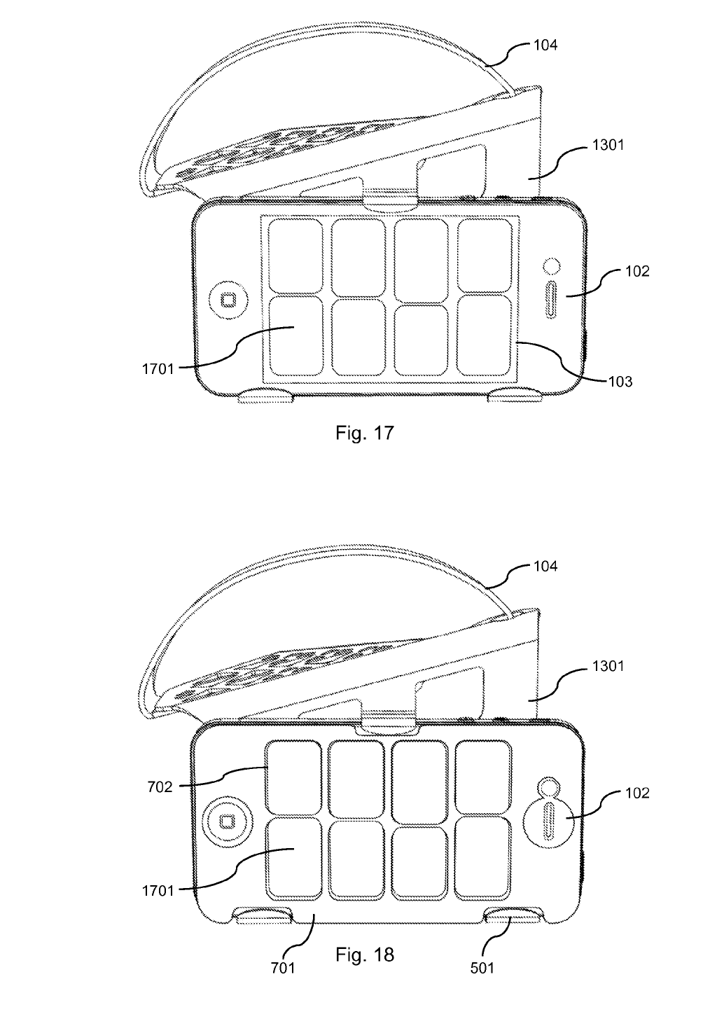

Exemplary embodiments may include software that is installed on a touch-sensitive unit This software may include the capacity to customize zones or points on the touch screen which trigger or otherwise control events. These zones or points will be referred to herein as “activation points”. For example, a series of activation points may be created on the touch screen, with each activation point being associated with a musical sound of a specific pitch, such that touch input to an activation point may trigger said musical sound and ceasing said touch input may end this sound. These musical sounds may have a distribution of pitches corresponding to a diatonic or chromatic scale. In exemplary embodiments these activation points may be used to trigger other entities, such as audio or visual samples. . In exemplary embodiments users may actuate activation points by contacting them with the tips of their digits. Sad software may allow the user to alter characteristics of the activation points including their number, layout, and size. One benefit of this configurability may be that users can create an activation point set up that well-suited to their needs, inducting ergonomic needs associated with the size of their palm and digits. In exemplary embodiments additional dimensions may be mapped onto the area within these activation points for the control of additional parameters. For example, an activation point may be comprised of a substantially rectangular area, and the bastion of digit contact within this area may determine the value of an outputted parameter. Examples of the number of activation points a user may elect to use are 4, 6, 7, 8, 12, or 13, but other numbers of activation points may also be chosen. As illustrated in FIG. 17, exemplary embodiments may include one or more activation points 1701 that are visible to the user on the touch-sensitive unit's touch screen 103. Exemplary embodiments may include one or more activation points that, while responsive to user touch, are not visible to the user on the touch-sensitive unit's touch screen. Exemplary embodiments may include visual effects that occur on the touch-sensitive unit's touch screen in response to user interaction with one or more activation points.

As illustrated in FIG. 17, exemplary embodiments may include a configuration of dip activation points 1701 organized into two rows of four. In exemplary embodiments where multiple rows of activation points are utilized the user may access the different rows by varying the flexion of their fingers. The benefit of providing eight activation points may be that this number is effective for providing access to the notes of a diatonic scale In this arrangement a pair of activation points may be allocated to each of the four fingers on a hand. In such exemplary embodiments each pair of activation points may be thought of as a column (forming a total of four vertical columns as illustrated in FIG. 17) whereby each of the four fingers of the user's hand may alternatively actuate the top activation point in the column or the bottom activation point n the column. For example, the user's index finger may vary its flexion to alternate between actuating the activation point on the bottom right or the top right (as defiled in reference to FIG. 17, however relative to the user this column is on the left).

In exemplary embodiments software operating on a touch-sensitive unit may also incorporate one or more data streams from said touch-sensitive units motion, orientation, or position sensors and utilize these data streams in its processes. Audio and/or video output from these applications may be transferred wirelessly or via cable to external equipment to be made audile, viewable, or to be recorded. Other output signals (e.g. MIDI or open sound control messages) may be transferred wirelessly or via cable to external equipment for further processing, transfer, or recording. These various forms of output may also be shared between software applications on a touch-sensitive unit In exemplary embodiments, primary software operating on a touch sensitive unit may process touch, motion, and/or orientation events and output this processed data as “virtual MIDI” signals (or another appropriate data protocol) to other secondary software operating on the same touch-sensitive unit. This secondary “receiving” software may produce audio and/or visual output in response to these virtual MIDI signals. Primary software operating on a touch-sensitive unit may provide the user with additional user interfaces on the touch screen, which all the processing and/or output of the sensor data to be configured.

In exemplary embodiments, output from an interface may be made audible, visible, or haptically-perceivable via components included in a touch-sensitive unit. For example, the touch-sensitive unit may provide output via an on-board speaker, or an on-board display screen, or a vibration motor. In exemplary embodiments, output from an interface may be made audible, visible, or haptically-perceivable via devices external to the interface. For example, output from the touch-sensitive unit may be sent via wired or wireless connections to one or more external speakers or visual displays. Exemplary embodiments may also include input of an audio signal (e.g. a singer's voice) to the touch-sensitive unit via an internal or external microphone (or other audio source) and perform pitch shifting or other forms of modulation on duplicate audio streams of this input as defined elsewhere in this description. In addition to the microphone input, exemplary embodiments may include an alternative ado stream supplied to the touch-sensitive unit from an alternative transducer (e.g. contact microphone). As explained elsewhere in this description and illustrated in FIG. 10, this alternative audio steam 1014 may be supplied to a pith detector 1003.

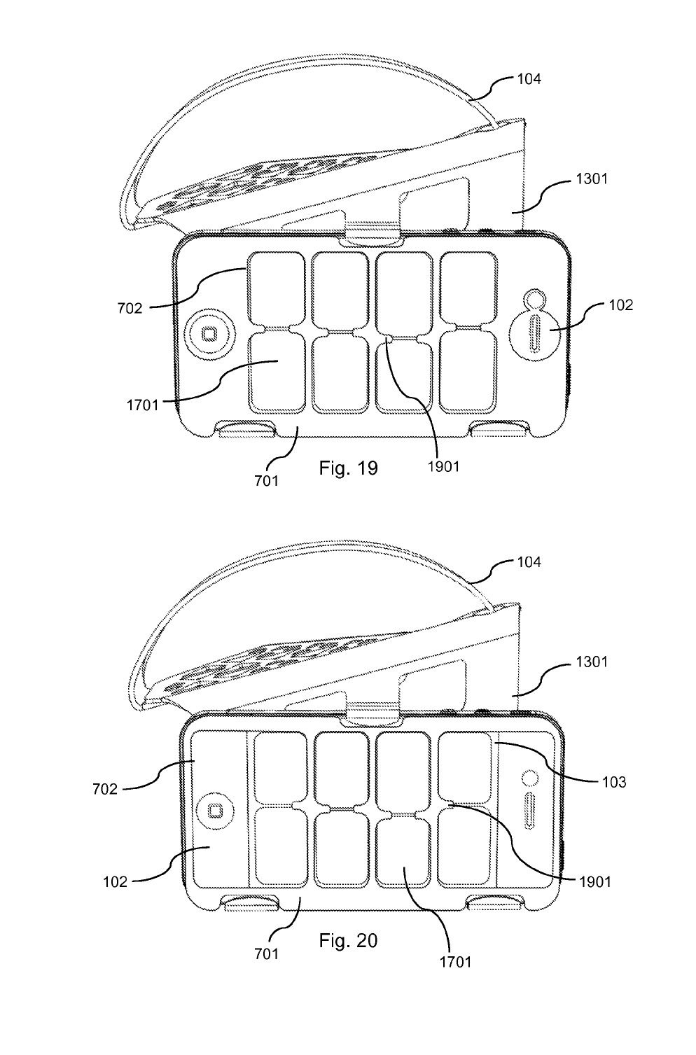

Exemplary embodiments may include an “overlay” component that rests on top of a touch-sensitive unit's touch screen. As illustrated in FIG. 18, FIG. 19, and FIG. 20, an overlay 701 may include one or more openings 702 in any variety of different quantities, sizes, and patterns. As illustrated in FIG. 18 an overlay 701 may include, for example, eight openings 702. The benefit of providing eight openings may be that this number is effective for providing access to the notes of a diatonic scale through the allocation of two buttons per finger. These openings may allow touch input to occur within their borders (onto the touch screen) while attempted input outside these borders (on to the surface of the overlay) may not be registered. By providing tactile feedback, such an overlay may assist the user in avoiding touching parts of the screen they did not intend to touch, and/or more reliably or precisely touching parts of the touch screen they did intend to touch. An additional benefit may be that such an overlay reduces the user's need to visually guide their interactions with the touch-sensitive unit's touch screen. Any number of openings or opening shapes may be utilized as part of an overlay. Such openings may have locations, sizes, and/or shapes that are substantially collocated with “activation points” as defined elsewhere in this description. So that the overlay does not substantially lose contact with the touch screen, the overlay may be secured to one or more sides of the platform 1301 or the touch-sensitive unit 102. As would be obvious to those skilled in the art a variety of mechanisms for securing the overlay to the platform or touch-sensitive unit may be used, including but not restricted to pins, magnets, clasps, hinges, slide rails, and so forth. As those skilled in the art would be aware, the overlay component itself may be constructed wholly or partially with a variety of different materials, including but not restricted to plastic, silicone, rubber, vinyl, wood, metal, and so forth. In exemplary embodiments the overlay may be constructed with substantially transparent, partially transparent, light-diffusing, or light-focusing material. The benefit of constructing the overlay from such materials may be that light from the touch-sensitive unit's touch screen is made visible in a manner pleasing to the viewer. In exemplary embodiments the overlay may be designed to be substantially rapidly moved away (e.g. slid or hinged) from the touch screen and vice versa. Software operating on the touch-sensitive unit may be designed to switch to an alternative user interface on the touch screen when the overlay is absent, and this presence/absence may be detected through the overlays interaction with the touch screen or one or more proximity sensors on the touch-sensitive unit.

In exemplary embodiments an overlay component may incorporate openings that extend over one or more activation points (as defined elsewhere in this description). As illustrated in FIG. 19 and FIG. 20, the overlay may provide tactile feedback to the user indicating the borders between activation points via border marker' protrusions 1901. The benefit of these border markers may be that they tactilely indicate the borders of activation points while leaving more of the touch-sensitive units touch screen uncovered, thereby facilitating other forms of interaction with the touch screen.

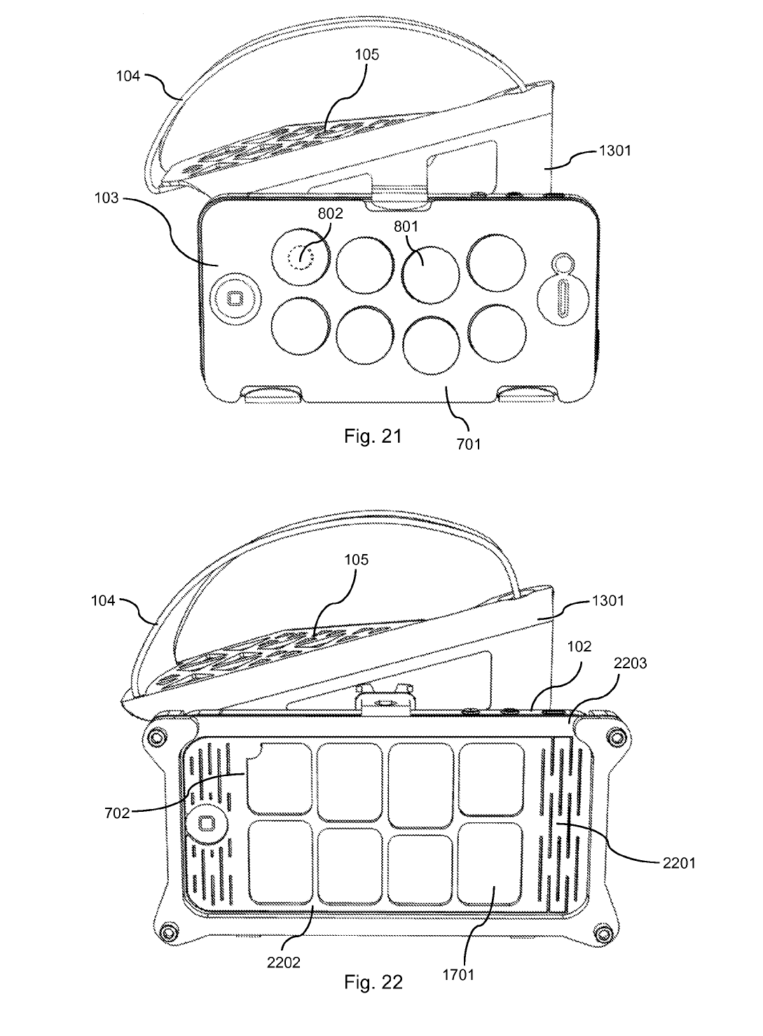

In exemplary embodiments an overlay component may incorporate substantially button-like components instead of openings. As illustrated in FIG. 21 such buttons 801 may be distributed across an overlay 701. A variety of button distributions may be implemented, for example, eight buttons. Such buttons may have locations, sizes, and/or shapes that are substantially co-located with “activation points” as defined elsewhere in this description. Each button may include, on its internal surface (the surface facing the touch screen), a touch-equivalent component 802. Such a touch-equivalent component may be capable of being registered as touch input when coming into contact NAM an activation point on the touch screen. As those skilled in the art would be aware, such an arrangement may operate similar to a membrane button or membrane switch. The button may be partially or wholly constructed from a substantially flexible material. When pressure is applied to the button by a digit (finger or thumb), this flexibility may allow the button to deform and the button's touch-equivalent component 802 to make contact with the touch screen, thereby being registered as a touch. When pressure applied by the digit is removed, the shape memory of the button material may cause the button to resume its original shape and the touch-equivalent component may retract away from the touch screen.

As those skilled in the art would be aware, each button component may be partially or wholly constructed with a variety of different materials, including but not restricted to plastic, silicone, rubber, vinyl, wood, metal, and so forth. Materials for the touch-equivalent component may be chosen depending on the touch screen or other touch-sensitive mechanism with which the touch-equivalent component is intended to interact For example, as would be obvious to those skilled in the art, the touch-equivalent component for a capacitance-based touch screen may be constructed Mil material that induces a conductance change on the touch screen, or transfers the capacitance properties of a user's digit to the touch screen. In the case of resistive touch screens the touch-equivalent component may be constructed with materials that can be pressed against, and exert sufficient pressure on, the resistive touch screen. Those skilled in the art would be aware that a variety of button mechanisms aside from the membrane type may be used in exemplary embodiments. A benefit of an overlay that includes one or more buttons may be that the user may touch the buttons prior to actuating them, with may allow substantially more temporally-accurate and/or spatially-accurate activations of the touch screen via the user's digits.

In exemplary embodiments a structure connected to the lower area of the palm pad 106 (see FIG. 16) may extend behind the user's wrist in the direction of their elbow (described with reference to the neutral operating position defined elsewhere in this description). The weight of the structure section positioned behind the user's wrist in the direction of their elbow may ad as a counterbalance to the weight of an interface and touch-sensitive unit in front of the user's wrist This counterbalance effect may make the interface more comfortable to use, especially during longer periods of use.

Exemplary embodiments may represent aspects of parameter control or audio output with substantially complementary visual components. In one example, specific notes within an octave may be represented as specific colours. In this example, the note C4 may be accompanied by a red colour, while D4 by an orange colour, E4 by a yellow colour, and so on, such that each note within the octave is associated with a specific colour. The distribution of colour across a diatonic or chromatic range may be continuous (as in the previous example), or discontinuous, such that neighbouring notes do not have corresponding colours that are substantially close (i.e. sequential) on the visible colour spectrum. In exemplary embodiments, note-colour pairing may be constant across octaves (such that C3, C4, and C5 may all be associated with the same colour), or the same notes in different octaves may have different colours. When more than one note is played simultaneously, the represented colour or other visual feature may cycle repeatedly through all the colours or visual features of the simultaneously active notes. Aspects of interface motion or orientation may affect features of the displayed colour, for example, colour saturation or brightness. In exemplary embodiments, shapes or other visual features may be linked to specific notes, instead of or in combination with the visual components described above. In exemplary embodiments the visual components (e.g. colours, shapes, and so on) associated with parameter control or audio output (e.g. notes) may be represented on the screen of a touch-sensitive unit For example, when a specific note is played via a touch-sensitive unit, the screen of sad touch-sensitive unit may produce the colour or other visual feature that matches sad note. Alternatively, exemplary embodiments may represent visual components via one or more external devices. Examples of external viewing devices may include, but are not limited to, televisions, computer screens, mobile computer screens, projection devices, wearable viewing devices, light displays and so on. Visual component data may be transferred from a touch-sensitive unit to the external viewing device via a physical or wireless connection.

In exemplary embodiments, aspects of parameter control or audio output may be represented as some form of visual avatar, personification, or character. For example, said avatar may perform certain actions in response to certain notes being triggered via a touch-sensitive unit and/or certain motions or orientations of a touch sensitive unit. Exemplary embodiments may host processes that form a game for the user on a touch-sensitive unit, which is used in association with an interface. One example of such a game may be the processes illustrated in FIG. 12A and FIG. 12B. Visual components of sad avatar, personification, character, or game may be represented on the screen of a touch-sensitive unit and/or one or more external viewing devices Examples of external viewing devices may include, but are not limited to, televisions, computer screens, mobile computer screens, projection devices, wearable viewing devices, light displays and so on. Such visual representations may be transferred from a touch-sensitive unit to an external viewing device via a physical or wireless connection.

In exemplary embodiments an overlay on the touch-sensitive surface or screen of a touch-sensitive unit may be designed to be substantially rapidly moved away from sad screen and subsequently substantially rapidly returned to said screen. For example, as illustrated in FIG. 22, a hinge 2201 may be located on one side of an internal overlay section 2202. Said hinge 2201 may connect sad internal overlay section 2202 to a surrounding overlay structure 2203. In this example the user may swing the internal overlay away from a touch-sensitive surface or screen of a touch sensitive unit (integrated with an interface), thereby allowing the user unobstructed access to sad screen. In an example illustrated in FIG. 22, a ‘living hinge’ design forms a hinge mechanism. However, as those skilled in the art would be aware, a variety of other hinge mechanisms may be employed instead.

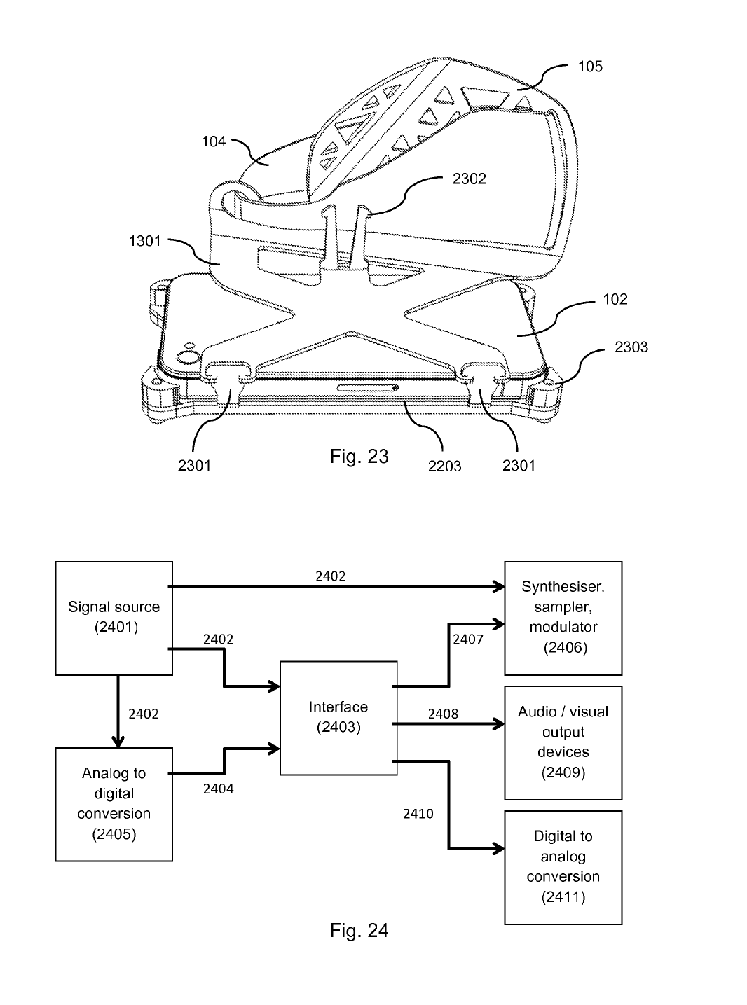

Exemplary embodiments may physically substantially capture a touch-sensitive unit via tabs that extend from an overlay and interact with a mounting platform and possibly also via stops protruding from the overlay and laying adjacent to one or more sides of the touch-sensitive unit. In an example illustrated in FIG. 23, two tabs 2301 may extend from a surrounding overlay structure 2203 over the bottom edge (as oriented in the figure) of a touch-sensitive unit 102, and one reversibly-attachable tab 2302 may extend over the top edge of the touch-sensitive unit. Unattaching the reversibly-attachable tab may allow the overlay to swing away from a platform 1301 (hinging at the bottom tabs 2301), thereby allowing the touch sensitive unit to be inserted or removed from the exemplary embodiment In this example, one or more stops 2303 may protrude from the corners of the overlay, thereby laying adjacent to one or more sides of the touch-sensitive unit

Illustrated in FIG. 24 are some example uses of exemplary embodiments. An interface 2403 referred to here may comprise one or more of the elements included in this description. Examples of such elements include, but are not limited to, a touch-sensitive unit, primary software operating on a touch-sensitive unit, and/or physical structures that physically associate a touch-sensitive unit with a user's hand. One or more signal sources 2401 (e.g. external or internal microphone) may provide analog input 2402 to an interface 2403 where this input may undergo analog to digital conversion and subsequent processing by components included in a touch-sensitive unit associated with the interface. Before being transferred to an interface, analog input may first be converted to a digital output format 2404 by an analog to digital conversion device 2405 that is external to an interface 2403, thereby allowing better analog to digital conversion than may be achievable via components included in a touch-sensitive unit Analog input 2402 may be transferred to a sampler and/or modulator device 2406 external to an interface 2403, and this sampler/modulator may process said analog input based in whole or part on instructions 2407 provided by an interface 2403 (for example, via physically or wirelessly transferred MIDI messages). A synthesizer and/or sampler device 2406 external to an interface 2403 may process and output audio and/or visual data based in whole or part on instructions 2407 provided by an interface 2403 (for example, via physically or wirelessly transferred MIDI messages). An interface 2403 may provide audio and/or visual data n analog or digital form 2408 to external output devices 2409 (e.g. audio amplifiers/speakers or external display devices) or output in one or all such mediums directly via components included on a touch-sensitive unit. An interface 2403 may provide audio and/or visual data in digital form 2410 to an external digital to analog conversion device 2411, thereby allowing better digital to analog conversion than may be achievable via components included in a touch-sensitive unit.

### Example 1

A hand operated input device or interface comprising: a platform for securing a touch-sensitive unit and additional structures that position the activation points of said touch-sensitive unit for operation by one or more of the user's digits;

The hand operated input device wherein sad touch-sensitive unit includes at least one sensor means for measuring a current motion, position, or orientation value of the input device.

The hand operated input device wherein attachment means secure the device to the user's hand.

The hand operated input device wherein structures are included that allow the hand operated input device to be gripped by the thumb or the thumb in combination with the palm (and/or the side of the palm adjacent to the thumb).

The hand operated input device wherein the input device is designed to remain in dose contact with the hand during operation.

The hand operated input device wherein the force of touch inputs to the touch-sensitive unit are substantially transferred to structures in contact with the user's palm, thereby bracing the touch-sensitive unit in its position relative to the user's hand.

The hand operated input device wherein an overlay with openings is positioned on a touch screen that is part of sad touch-sensitive unit.

The hand operated input device wherein an overlay with buttons is positioned on a touch screen that is part of sad touch-sensitive unit

The hand operated input device wherein the output of said sensor means modulates the outcomes controlled by said activation points.

The hand operated input device wherein the output of said activation points modulates the outcomes controlled by said sensor means.

The hand operated input device wherein the activation points are mapped to sounds that differ in perceived *h.

The hand operated input device wherein the activation points are mapped to control different audio or video samples, or different time point within audio or video samples.

The hand operated input device wherein combined actuation of activation points increases the number of output stets that can be produced beyond the number of activation points.

The hand operated input device wherein the actuation of specific activation points modulates the output of other actuation means, whereby the number of output states that can be produced is increased beyond the number of activation points.

The hand operated input device wherein sad sensor means include at least one angular rate sensor measuring the rat of angular rotation of the device around the lateral, longitudinal, or vertical axis of the device.

The hand operated input device wherein sad sensor means include at least one orientation sensor measuring the orientation of the device around the lateral, longitudinal, or vertical axis of the device.

The hand operated input device wherein sad sensor means measure the orientation of the device around the lateral, longitudinal, and vertical axes of the device.

The hand operated input device wherein sad sensor means measure the orientation of the device around the lateral and longitudinal axes of the device.

The hand operated input device wherein the sensor means measure at least one position value of the device.

The hand operated input device wherein the sensor means measure at least one translational motion value of the device.

The hand operated input device wherein sad device further includes an elongated portion counterbalancing, across the wrist, the weight of the front section of the hand operated input device when in use by a user.

The hand operated input device wherein the position of one or more activation points is adjustable.

The hand operated input device wherein the distance of one or more activation points from the user's palm is adjustable.

The hand operated input device wherein the lateral position of one or more activation points relative to the user's palm is adjustable.

The hand operated input device wherein the angle of the platform on which the touch-sensitive units is positioned, is adjustable relative to the user's palm.

The hand operated input device wherein sad attachment means are adjustable.

The hand operated input device wherein the distance of the device's contact surface for the user's attached hand relative to the rest of the device is adjustable.

The hand operated input device wherein the device's contact surface for the user's attached hand includes ventilation means.

The hand operated input device wherein sad processing means includes a wireless transmission means for wireless transmission of the output

The hand operated input device wherein sad processing means includes a cable transmission means for cabled transmission of the output

The hand operated input device wherein each of the activation points can be actuated either individually or in combination with other activation points.

The hand operated input device wherein at least one axis of the orientation of the device is mapped to output the octave of a sound's perceived pitch.

The hand operated input device wherein one or more rates of rotational or translational motion of the device are mapped as control parameters for audio or visual effects.

The hand operated input device wherein orientation or position of the device is mapped as a control parameter for audio or visual effects.

The hand operated input device wherein the direction of rotational or translational motion of the device acts as a method for selecting specific audio or visual outcomes.

The hand operated input device wherein at least one measurement of rotational motion, translational motion, orientation, or position of the device acts to modulate audio or visual outcomes controlled by another measurement of rotational motion, translational motion, orientation, or position.

The hand operated input device wherein the activation of a musical note is accompanied by the display of one or more associated colours.

The hand operated input device wherein features of displayed colours, like saturation or brightness, are controlled by the orientation, location, and/or motion of the said input device.

The hand operated input device wherein the activation of a musical note is accompanied by the display of one or more shapes or visual patterns.

The hand operated input device wherein features of displayed shapes or visual patterns are controlled by the orientation, location, and/or motion of the said input device.

The hand operated input device wherein user input via activation points or motion, location, and/or orientation changes of sad input device are represented in the appearance and/or behavior of an avatar or personification.

The hand operated input device wherein displayed colours, shapes, visual patterns, or avatars are displayed on an external display.

The hand operated input device wherein a tactile overlay may be substantially rapidly and reversibly moved away from a screen that is included in said input device.

The hand operated input device wherein motion-, location- and/or orientation-based control signals are outputted to a vocal harmony generation device.

The hand operated input device as wherein one or more axes of the orientation of the device is mapped to a series of zones.

The hand operated input device wherein the device is used to interact with a video game.

The hand operated input device wherein the device is used to control a lighting system.

The hand operated input device wherein the device is used to remotely control a robot or vehicle.

The hand operated input device wherein the device provides haptic feedback to the user.

The hand operated input device wherein the device sends input to audio or visual processing software on a computer.

The hand operated input device wherein the device sends input to audio or visual entertainment equipment or hardware.

The hand operated input device wherein the device is used to modify at least one of an audio signal and a video signal.

The hand operated input device wherein the sensor means comprises at least one of an accelerometer that measures static acceleration, an accelerometer that measures dynamic acceleration, a gyroscope that measures rotational motion, or a magnetometer that measures magnetic fields.

The hand operated input device wherein the position of the device is estimated based on the interaction between a signal emitter and a signal receiver, one of which is boated in the device and the other of which is physically separate to the device.

The hand operated input device wherein sounds controlled by the device can be modulated by a portamento effect controlled by the sequence of actuation of activation points and/or motion, orientation, or position of the device.

The hand operated input device wherein sounds controlled by the device can be modulated by a vibrato effect controlled by motion, orientation, or position of the device after the actuation of activation points.

The hand operated input device wherein sounds controlled by the device can be modulated by a tempo-synced oscillation rate-based effect controlled by the orientation or position of the device and/or directions of motion of the device.

The hand operated input device wherein one or more rates of rotational or translational motion of the device modulates a sound in an similar way to which bowing velocity modulates the sound of a stringed instrument or breath velocity modulates the sound of a wind instrument

The hand operated input device wherein activation points are mapped to letters or numbers and motion, position, or orientation modulates this mapping.

The hand operated input device wherein the device includes an arrangement of activation points subdivided into sets assigned to each digit, the number of sets being at least four.

The hand operated input device wherein the device includes an arrangement of activation points subdivided into sets assigned to each digit, the number of sets being at least three.

### Example 2

A hand operated input device or interface comprising: a plurality of activation points configured to be activated by the digits of the user; at least one sensor means for measuring a current motion, position, or orientation value of the input device; and a processing means connected to the activation points and the sensor means for processing or outputting a series of currently active activation points and at least one of the motion, position, or orientation values of the input device.

The hand operated input device wherein movement of the device controls the rate of playback of an audio sample (the “control audio sample”).

The hand operated input device wherein the control audio sample is a person's sung or spoken voice.

The hand operated input device wherein the control audio sample is a sound that can be controlled for musical effect.

The hand operated input device wherein the pith and audibility of the control audio sample is independent of its rate of playback

The hand operated input device wherein control over a visual video component sample associated with the control audio sample is simultaneously exerted via the input device.

The hand operated input device wherein one or more distinct audio samples is simultaneously played back at a constant rate that is not controlled via the input device.

The hand operated input device wherein actuation of activation points is used to control the pitch of the control audio sample.

The hand operated input device wherein actuation of activation points is used to gate the audibility of the control audio sample.

The hand operated input device wherein actuation of activation points is used to select between control audio samples or playback start points within control audio samples.

The hand operated input device wherein an axis of orientation of the device is used to control the pitch of the control audio sample.

The hand operated input device wherein visual and/or audio elements provide instructions and feedback on exerting said controls via the device.

The hand operated input device wherein sequential sections of the control audio sample require specific directions of device movement for playback, and these directions are Visually indicated.

The hand operated input device wherein visual and/or audio elements provide feedback on a users performance of control thereby imbuing a game-like quality to the task

### Example 3

An entertainment system comprising: a user input device providing a series of user-controlled input data streams comprising substantially continuous input values and substantially discrete input values; and an processing component connected to sad user input data streams; wherein said processing component processes or outputs said input data streams for playback control of an audio sample (the “control audio sample”).

The system wherein user-controlled substantially continuous input data control the rate of playback of an audio sample.

The system wherein the control audio sample is a person's sung or spoken voice.

The system wherein the control audio sample is a sound that can be controlled for musical effect

The system wherein the pitch and audibility of the control audio sample is independent of its rate of playback

The system wherein control over a visual video component sample associated with the control audio sample is simultaneously exerted by user-controlled substantially continuous input data.

The system wherein one or more distinct audio samples is simultaneously played back at a constant rate that is not controlled by the user.

The system wherein user-controlled discrete input values are used to gate playback of sections of the control audio sample, and/or to control the pitch of the control audio sample.

The system wherein user-controlled discrete input values are used to control the pitch of the control audio sample.

The system wherein user-controlled discrete input values are used to gate the audibility of the control audio sample.

The system wherein user-controlled discrete input values are used to select between control audio samples or playback start points within control audio samples.

The system wherein visual and/or audio elements provide instructions and feedback on exerting said controls.

The system wherein control of one or more sequential sections of the control audio sample requires a direction-specific user action, with the required direction indicated visually.

The system wherein visual and/or audio elements provide feedback on a user's performance of control thereby imbuing a game-like quality to the task.

### Example 4

A hand operated input device or interface comprising: a plurality of activation points configured to be activated by the digits of the user; at least one sensor means for measuring a current motion, position, or orientation value of the input device; and a processor means interconnected to the activation points and the sensor means for processing or outputting a series of currently active activation points and at least one motion, position, or orientation value of the input device; wherein movement of the device modulates one or more duplicate audio streams derived from an audio source (e.g., a voice recorded by a microphone).

The hand operated input device wherein the activation points and/or device movement is used to control the volume of one or more duplicate audio streams.

The hand operated input device wherein the activation points are used to control the pitch of one or more duplicate audio streams.

The hand operated input device wherein the audio source and one or more duplicate audio streams are made audile (and/or recordable) at the same time to produce harmony.

The hand operated input device wherein only one or more duplicate audio streams are made audile (and/or recordable).

The hand operated input device wherein motion, orientation, or position of the device is used to control the volume and/or other audio qualities of one or more duplicate audio streams.

The hand operated input device wherein the pitch of one or more duplicate audio streams is selected by a musical pitch interval relative to the pitch of the audio source, whereby each specific pitch interval is triggered by a specific activation point

The hand operated input device wherein the pith of one or more duplicate audio streams is selected as a specific pitch, whereby each specific pitch is triggered by a specific activation point

The hand operated input device wherein the pith of one or more duplicate audio streams and/or the source audio is quantized.

The hand operated input device wherein supplementary transduction of the ado source is achieved using a contact microphone and the resulting signal is analyzed to detect one or more pitches within the audio source.

The hand operated input device wherein the pitch of one or more duplicate audio streams can be modulated by a portamento effect controlled by the sequence of actuation of activation points and/or motion, orientation, or position of the device.

The hand operated input device wherein the pith of one or more duplicate audio streams can be modulated by a vibrato effect controlled by the motion, orientation, or position of the device afteractuation of an activation point.

The hand operated input device wherein sounds controlled by the device can be modulated by a tempo-synchronized oscillation rate effect controlled by the orientation or position of the device and/or directions of motion of the device.

Example 5

An entertainment system comprising: a user input device providing a series of user-controlled input data steams comprising substantially continuous input values and substantially discrete input values; and an processing component interconnected to said user input data steams; wherein said processing component processes or outputs said input data streams for modulation of one or more duplicate audio streams derived from an audio source (e.g., a voice recorded by a microphone).

The system wherein said user-controlled input data controls the volume and/or other parameters of one or more duplicate audio steams.

The system wherein user-controlled discrete input values are used to control the pitch of one or more duplicate audio streams.

The system wherein the audio source and one or more duplicate audio steams are made audible (and/or recordable) at the same time to produce harmony.

The system wherein user-controlled substantially continuous input data control the volume and/or other audio qualities of one or more duplicate audio streams.

The system wherein the pitch of one or more duplicate audio streams is selected by a musical pitch interval relative to the pitch of the audio source, whereby each specific pitch interval is triggered by a specific user-controlled discrete input value.

The system wherein the pitch of one or more duplicate audio streams is selected as a specific pitch, whereby each specific pitch is triggered by a speck user-controlled discrete input value.

The system wherein the pitch of one or more duplicate audio streams and/or the source audio is quantized.

The system wherein supplementary transduction of the audio source is achieved using a contact microphone and the resulting signal is analyzed to detect one or more pitches within the audio source.

The system wherein the pitch of one or more duplicate audio streams can be modulated by a portamento effect controlled by the sequence of user-controlled discrete input values and/or user-controlled substantially continuous input data.

The system wherein the pitch of one or more duplicate audio streams can be modulated by a vibrato effect that responds to specific combinations of user-controlled discrete values and substantially continuous input data.

The system wherein the sound of one or more duplicate audio streams can be modulated by a tempo-synced oscillation rate-based effect that responds to user-controlled substantially continuous input data.

### Example 6

A hand operated input device or interface comprising: a plurality of activation points configured to be activated by the digits of the user; at least one sensor for measuring a current motion, position, or orientation value of the input device; and an processing means interconnected to the activation points and the sensor for processing a series of currently active activation points and at least one motion, position, or orientation value of the input device; wherein movement of the device controls the substantially gradated change in the pitch of a sound between a start pitch and an end pitch.

The hand operated input device wherein activation points are used to select sad start pitch and end pitch.

The hand operated input device wherein, after selection of the start and end pitches, motion of the device controls the substantially gradated change in the pitch of a sound between the start pitch and the end pitch.

The hand operated input device wherein a user may operate left and right-handed versions of the input device simultaneously and differences in at least the relative motion, position, or orientation of the two devices is used to control the substantially gradated change in the pitch of a sound between a start pitch and an end pitch.

### Example 7

An entertainment system comprising: a user input device providing a series of user-controlled input data streams comprising substantially continuous input values and substantially discrete input values; and an processing component interconnected to said input data steams; wherein sad processing component processing said input data streams to control the substantially gradated change in the pitch of a sound between a start pitch and an end pitch.

The system wherein substantially discrete input values are used to select a start pitch and an end pitch.

The system wherein substantially continuous input values are used to control the substantially gradated change in the pitch of a sound between a start pitch and an end pitch.

### Example 8

A hand operated input device or interface comprising: a plurality of activation points configured to be activated by the digits of the user; at least one sensor for measuring a current motion, position, or orientation value of the input device; and an processing means interconnected to the activation points and the sensor for processing or outputting a series of currently active activation points and at least one of the motion, position, or orientation values of the input device; wherein movement of the device controls the playback of an audio sample and/or an associated visual video component sample.

The hand operated input device wherein the audio sample is pre-processed to part* or completely reduce its pitch variability, after which the pitch or pitches of the audio sample is detected at one or more points in the duration of the audio sample.

The hand operated input device wherein control over a visual video component sample associated with the audio sample is simultaneously exerted via the input device.

The hand operated input device wherein the pitch and audibility of the audio sample is independent of its rate of playback.

The hand operated input device wherein the audio and/or an associated visual video component sample can be played forwards and backwards at any rate.

The hand operated input device wherein activation point inputs are used to gate the audibility and control the pitch of the audio sample.

The hand operated input device wherein motion, position, and/or orientation values of the input device; and/or activation points of the input device, control additional modulation of the audio sample.

The hand operated input device wherein motion, position, and/or orientation values of the input device; and/or activation points of the input device, control additional modulation of the visual video component sample.

The hand operated input device wherein the pitch of the audio sample can be modulated by a portamento effect controlled by the sequence of actuation of activation points and/or motion, orientation, or position of the device.

The hand operated input device wherein the pitch of the audio sample can be modulated by a vibrato effect controlled by motion, orientation, or position of the device after actuation of one or more activation points.

The hand operated input device wherein the sound of the audio sample can be modulated by a tempo-synced oscillation rate effect controlled by the orientation or position of the device and/or directions of motion of the device.

### Example 9

An entertainment system comprising: a user input device providing a series of user-controlled input data streams comprising substantially continuous input values and substantially discrete input values; and an processing component interconnected to sad user input data steams; wherein sad processing component uses sad input data streams to control the playback of an audio and/or an associated visual video component sample.

The system wherein the audio sample is pre-processed to partially or completely reduce its pitch variability, after which the pitch or pitches of the audio sample is detected at one or more points in the duration of the audio sample.

The system wherein control over a visual video component sample associated with the audio sample is simultaneously exerted via the substantially continuous input values.

The system wherein the pitch and audibility of the audio sample is independent of its rate of playback.

The system wherein the audio and/or an associated visual video component sample can be played forwards and backwards at any rate.

The system wherein the substantially discrete input values are used to gate the audibility and control the pitch of the audio sample.

The system wherein the substantially continuous input values and/or the substantially discrete input values control additional modulation of the audio sample.

The system wherein the substantially continuous input values and/or the substantially disc ret input values control additional modulation of the visual video component sample.

The system wherein the pitch of the audio sample can be modulated by a portamento effect controlled by the sequence of user-controlled discrete input values and/or user-controlled substantially continuous input data

The system wherein the pitch of the audio sample can be modulated by a vibrato effect that responds to specific combinations of user-controlled discrete values and substantially continuous input data.

The system wherein the audio sample can be modulated by a tempo-synced oscillation rate effect that responds to user-controlled substantially continuous input data.

### Example 10

An entertainment system comprising: a user input device providing a series of user controlled input data streams derived from a current device movement, position, or orientation, and outputs musical sound audio data with substantially gradated pitch control depending on sad data streams of the user input device.

The system wherein the input device comprises: a plurality of activation point configured to be activated by the digits of the user; at least one sensor component for measuring a current motion, position, or orientation value of the hand of a user; and a processing means interconnected to the activation points and the sensor component for outputting a series of currently active activation points and at least one of the motion, position, or orientation values of the input device.

The music entertainment system wherein the start and end pitches of said substantially gradated pitch control depend on current discrete data events initiated by the user via controls provided by the input device.

### Example 11

A method of producing an interactive musical sound, the method including the steps of: (a) providing a user input device providing a series of user-controlled input data steams derived from a current device movement, position, or orientation; (b) processing sad user input device data, to output musical sound audio data with substantially gradated pitch control depending on sad data streams of the user input device.

The method wherein the start and end pitches of said substantially gradated pith control depend on current discrete data events initiated by the user via controls provided by the input device.

### Example 12

An entertainment system comprising: a user input device providing a series of user-controlled input data steams derived from a current device movement, position, or orientation; a video steam having both audio and associated video information; and a processor interconnected to said user input device and said video stream, said processor outputting video at a specific position in the video steam, dependent on said movement, position, or orientation data streams of the user input device, and a current audio output derived from audio at said specific position in the video steam.

The system wherein the user input device comprises: a plurality of activation points configured to be activated by the digits of the user; at least one sensor component for measuring a current motion, position, or orientation value of the input device; and an processing component interconnected to the activation points and the position sensors for processing or outputting a series of currently active activation points and at least one of the motion, position, or orientation values of the input device.

The system wherein current audio output derived from audio at said specific position in the video stream is pitched in accordance with current discrete data events initiated by the user via controls provided by the input device.

### Example 13

A method of producing an interactive video image, the method including the steps of: (a) providing a user input device providing a series of user-controlled input data streams derived from a current device movement, position, or orientation; (b) providing a video stream having both audio and associated video information; and (c) processing said video stream, to output video at a specific position in said video steam, dependent on said movement, position, or orientation data streams of the user input device, and to output audio derived from audio at said specific position in the video stream.

The method wherein current audio output derived from audio at said specific position in the video stream is pitched in accordance with current discrete data events initiated by the user via controls provided by the input device.

### Example 14

A hand operated input device or interface comprising: a plurality of activation points configured to be activated by the digits of the user; at least one sensor means for measuring a current motion, position, or orientation value of the input device; and a processing means interconnected to the activation points and the sensor means for processing or outputting a series of currently active activation points and at least one of the motion, position, or orientation values of the input device.

The hand operated input device wherein the activation points are mapped to musical notes.

The hand operated input device wherein the number of activation points per digit is at least 2.

The hand operated input device wherein the number of activation point per digit is at least 3.

The hand operated input device wherein the digits include fingers of a user and the thumb.

The hand operated input device wherein the sensors include at least one angular rate sensor sensing the rate of angular rotation of the device.

The hand operated input device wherein said sensor outputs a roll, pitch, and yaw indicator of the device.

The hand operated input device wherein sad sensor means output a roll and pitch indicator of the device.

The hand operated input device wherein the sensor means measure at least one position value of the device.

The hand operated input device wherein the sensor means measure at least one movement value of the device.

The hand operated input device wherein sad device further includes an elongated portion counterbalancing the weight of the activation poets when in use by a user.

The hand operated input device wherein the positions of the activation points are adjustable for one or more digits.

The hand operated input device wherein the activation points are formed from electromechanical snitches

The hand operated input device wherein the activation pints are located on a touch screen.

The hand operated input device wherein sad processing means is interconnected to a wireless transmission means for wireless transmission of the output.

The hand operated input device wherein each of the activation points can be actuated either individually or in combination with other activation points.

The hand operated input device wherein at least one axis of the orientation of the device is mapped to output the octave of a note's pitch.

The hand operated input device wherein a rate of rotational motion of the device is mapped as a control parameter.

The hand operated input device wherein one or more axes of the orientation of the device is mapped to a series of zones.

The hand operated input device wherein the device is used to interact with a video game.

The hand operated input device wherein the device is used to modify at least one of an audio signal and a video signal.

The hand operated input device wherein the positioning sensor comprises at least one of an accelerometer that measures static acceleration, an accelerometer that measures dynamic acceleration, a gyroscope that measures rotational motion, or a magnetometer that measures magnetic fields.

The hand operated input device wherein the device is designed to remain in dose contact With the hand during movement.

The hand operated input device wherein the device incorporates measurement of controller motion using a gyroscope and/or accelerometer.

The hand operated input device wherein the device includes an arrangement of activation points subdivided into sets assigned to each digit, the number of sets being at least four.

The hand operated input device wherein the device includes an arrangement of activation points subdivided Vito sets assigned to each digit, the number of sets being at least three.

### Example 15

A method for manipulating audio/visual content, the method comprising:

Providing a plurality of activation points on an input device configured to be activated by the digits of the user; providing at least one sensor for measuring a current motion, position, or orientation value of said input device; and processing or outputting a series of currently active activation point and at least one of the motion, position, or orientation values of said input device.

The method wherein the activation points are mapped to musical notes.

The method further comprising transmitting the output data.

The method wherein each of the actuation points can be actuated either individually or in combination with other activation points.

The method wherein the method s used to interact with a video game.

### Example 16

A hand operated input device or interface comprising: a plurality of activation points configured to be activated by the digits of the user; at least one sensor means for measuring a current motion, position, or orientation value of the input device; and a processing means interconnected to the activation points and the sensor means for processing or outputting a series of currently active activation points and at least one motion, position, or orientation value of the input device.

The hand operated input device wherein the activation points are mapped to audio or video samples, or different time points within audio or video samples.

The hand operated input device wherein movement of the device controls the rate of playback of audio or video samples from the time points selected by actuation of the activation points.

The hand operated input device wherein any angular rotation around the vertical axis of the device advances the playback of the selected audio or video sample forwards at a rate proportional to the rotation.

The hand operated input device wherein one direction of angular rotation around the vertical axis of the device advances the playback of the selected audio or video sample forwards at a rate proportional to the rotation, while the other direction advances the playback of the selected audio or video sample backwards at a rate proportional to the rotation.

### Example 17

A hand operated input device or interface comprising: a platform for securing a touch-sensitive unit and additional structures that position activation points located on said touch-sensitive unit for operation by one or more of the use's digits;

The hand operated input device wherein sad touch-sensitive unit includes at least one sensor means for measuring a current motion, position, or orientation value of the input device.

The hand operated input device wherein attachment means secure the device to the user's hand.

The hand operated input device wherein structures are included that allow the hand operated input device to be gripped by the thumb or the thumb in combination with the palm (and/or the side of the palm adjacent to the thumb).

The hand operated input device wherein the input device is designed to remain in dose contact with the hand during operation.

The hand operated input device wherein the force of touch inputs to the touch-sensitive unit are substantially transferred to structures in contact with the user's palm, thereby bracing the touch-sensitive unit in its position relative to the user's hand.

The hand operated input device wherein sad platform and additional structures orient the longest edge of the touch-sensitive unit such that it is substantially non-parallel to the plane of the palm of the user's hand.

The hand operated input device wherein sad platform and additional structures only include essential structural material to reduce weight.

The hand operated input device wherein sad attachment means include a strap that is wider on the little finger side of the user's hand than on the index finger side of the user's hand.

The hand operated input device wherein an overlay with openings is positioned on a touch screen that is part of said touch-sensitive unit

The hand operated input device wherein an overlay with buttons is positioned on a touch screen that is part of sad touch-sensitive unit.

The hand operated input device wherein an overlay with buttons is positioned on a touch-sensitive area that is part of sad touch-sensitive unit

The hand operated input device wherein an overlay with openings is positioned on a touch sensitive area that is part of said touch-sensitive unit

The hand operated input device wherein an overlay is constructed with one or more materials that transports light from overlay-covered areas of the touch-sensitive unit to, and outward from, the external surface of said overlay.

The hand operated input device wherein an overlay includes tactile indicators of locations below it on sad touch-sensitive unit.

The hand operated input device wherein an overlay includes an attachment mechanism that allows the overlay to vary its position relative to said touch screen.

The hand operated input device wherein sad attachment mechanism acts to shift the overlay either substantially dose to or away from said touch screen, thereby acting to keep the overlay out of the continuous range of locations between these two positions.

The hand operated input device wherein an overlay includes a mechanism that reversibly locks the overlay into a position that is substantially dose sad touch screen.

The hand operated input device wherein an overlay includes a mechanism that reversibly ticks the overlay into a position away from said touch screen.

The hand operated input device wherein an overlay includes an attachment mechanism that allows the overlay to rotate substantially close to or away from sad touch screen.

The hand operated input device wherein an overlay includes an attachment mechanism that allows the overlay to side substantially dose to or away from sad touch screen.

The hand operated input device wherein shifting sad overlay away from the position where it is substantially dose to sad touch screen automatically triggers a change in user interface on sad touch screen.

The hand operated input device wherein supplementary transduction of an audio source is achieved using a contact microphone and the resulting signal is transferred to, and analyzed by, sad touch-sensitive unit and one or more perceived pitches within the audio source are estimated.

The hand operated input device wherein sad contact microphone-based pitch estimate acts as a variable in calculations that determine the direction and amount of pitch shifting to be applied to an additional stream of the same audio source that is transduced and transferred to the touch-sensitive unit by a conventional microphone.

The hand operated input device wherein the output of said sensor means modulates the outcomes controlled by said activation points.

The hand operated input device wherein the output of said activation points modulates the outcomes controlled by said sensor means.

The hand operated input device wherein the activation points are mapped to sounds that differ in perceived pitch.

The hand operated input device wherein the activation points are mapped to control different audio or video samples, or different time points within audio or video samples.

The hand operated input device wherein combined actuation of activation points increases the number of output states that can be produced beyond the number of activation points.

The hand operated input device wherein the actuation of specific activation points modulates the output of other actuation means, whereby the number of output states that can be produced is increased beyond the number of activation points.

The hand operated input device wherein said sensor means include at least one angular rate sensor measuring the rate of angular rotation of the device around the lateral, longitudinal, or vertical axis of the device.

The hand operated input device wherein sad sensor means include at least one orientation sensor measuring the orientation of the device around the lateral, longitudinal, or vertical axis of the device.

The hand operated input device wherein said sensor means measure the orientation of the device around the lateral, longitudinal, and vertical axes of the device.

The hand operated input device wherein sad sensor means measure the orientation of the device around the lateral and longitudinal axes of the device.

The hand operated input device wherein the sensor means measure at least one position value of the device.

The hand operated input device wherein the sensor means measure at least one translational motion value of the device.

The hand operated input device wherein sad device further includes an enlongated portion counterbalancing, across the wrist, the weight of the front section of the hand operated input device when in use by a user.

The hand operated input device wherein the position of one or more activation points is adjustable.

The hand operated input device wherein the distance of one or more activation points from the user's palm is adjustable.

The hand operated input device wherein the lateral position of one or more activation points relative to the user's palm is adjustable.

The hand operated input device wherein the angle of the platform on which the touch-sensitive units is positioned, is adjustable relative to the user's palm.

The hand operated input device wherein sad attachment means are adjustable.

The hand operated input device wherein the distance of the device's contact surface for the user's attached hand relative to the rest of the device is adjustable.

The hand operated input device wherein the device's contact surface for the user's attached hand includes ventilation means.

The hand operated input device wherein sad processing means includes a wireless transmission means for wireless transmission of the output.

The hand operated input device wherein sad processing means includes a cable transmission means for cabled transmission of the output.

The hand operated input device wherein each of the activation points can be actuated either individually or in combination with other activation points.

The hand operated input device wherein at least one axis of the orientation of the device is mapped to output the octave of a sound's perceived pitch.

The hand operated input device wherein one or more rates of rotational or translational motion of the device are mapped as control parameters for audio or visual effects.

The hand operated input device wherein orientation or position of the device is mapped as a control parameter for audio or visual effects.

The hand operated input device wherein the direction of rotational or translational motion of the device acts as a method for selecting specific audio or visual outcomes.

The hand operated input device wherein at least one measurement of rotational motion, translational motion, orientation, or position of the device acts to modulate audio or visual outcomes controlled by another measurement of rotational motion, translational motion, orientation, or position.

The hand operated input device as wherein one or more axes of the orientation of the device is mapped to a series of zones.

The hand operated input device wherein the device is used to interact with a video game.

The hand operated input device wherein the device is used to control a lighting system.

The hand operated input device wherein the device is used to remotely control a robot or vehicle.

The hand operated input device wherein the device provides haptic feedback to the user.

The hand operated input device wherein the device sends input to audio or visual processing software on a computer.

The hand operated input device wherein the device sends input to audio or visual entertainment equipment or hardware.

The hand operated input device wherein the device is used to modify at least one of an audio signal and a video signal.

The hand operated input device wherein the sensor means comprises at least one of an accelerometer that measures static acceleration, an accelerometer that measures dynamic acceleration, a gyroscope that measures rotational motion, or a magnetometer that measures magnetic fields.

The hand operated input device wherein the position of the device is estimated based on the interaction between a signal emitter and a signal receiver, one of which is located in the device and the other of which is physically separate to the device.

The hand operated input device wherein sounds controlled by the device can be modulated by a portamento effect controlled by the sequence of actuation of activation points and/or motion, orientation, or position of the device.

The hand operated input device wherein sounds controlled by the device can be modulated by a vibrato effect controlled by motion, orientation, or position of the device after the actuation of activation points.

The hand operated input device wherein sounds controlled by the device can be modulated by a tempo-synced oscillation rate-based effect controlled by the orientation or position of the device and/or directions of motion of the device.

The hand operated input device wherein one or more rates of rotational or translational motion of the device modulates a sound in an similar way to which bowing velocity modulates the sound of a stringed instrument or breath velocity modulates the sound of a wind instrument.

The hand operated input device wherein activation points are mapped to letters or numbers and motion, position, or orientation modulates this mapping.

The hand operated input device wherein the device includes an arrangement of activation points subdivided into sets assigned to each digit, the number of sets being at least four.

The hand operated input device wherein the device includes an arrangement of activation points subdivided Vito sets assigned to each digit, the number of sets being at least three.

In the description of exemplary embodiments of this disclosure, various features are sometimes grouped together in a single embodiment, figure or description thereof for the purpose of streamlining the disclosure and aiding in the understanding of one or more of the various disclosed aspects. This method of disclosure, however, is not to be interpreted as reflecting an intention that the claimed inventions requires more features than are expressly recited in each claim. Rather, as the following claims reflect, inventive aspects may lie in less than all features of a single foregoing disclosed embodiment Thus, the claims following the Detailed Description are hereby expressly incorporated into this Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those in the art.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element deserted herein of an apparatus embodiment is an example of away of carrying out the function performed by the element for the purpose of carrying out the disclosed inventions.

In the claims below and the description herein, the terms comprising, comprised of or which comprises are open terms that mean including at least the elements features that follow, but not excluding others. Thus, the terra comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Although the present disclosure makes particular reference to exemplary embodiments thereof, variations and modifications can be effected within the spirit and scope of the following claims.

1. An interface comprising:
a structure that can move in physical association with a user's hand and support a touch-sensitive unit for operation by one or more of the digits of said hand.

2. The interface as claimed in claim 1 wherein the interface is in a substantially fixed position relative to the user's hand while in use.

3. The interface as claimed in claim 1 wherein the interface includes components that attach the interface to the user's hand.

4. The interface as claimed in claim 1 wherein the touch-sensitive unit's touch activation points are mapped to musical notes.

5. The interface as claimed in claim 1 wherein the touch-sensitive unit includes at least one sensor for measuring a current rotational motion, translational motion, position, or orientation value.

6. The interface as claimed in claim 1 wherein an overlay on the touch-sensitive component of the touch-sensitive unit guides input to said touch-sensitive component.

7. The interface as claimed in claim 1 one or more of the previous claims wherein at least one of a rotational motion, translational motion, position, or orientation value of the touch-sensitive unit is used to modulate audio or visual outcomes.

8. The interface as claimed in claim 1 wherein the interface secures the touch-sensitive unit in said support location.

9. The interface as claimed in claim 1 wherein a section of the interface in contact with the palm of said hand braces the touch-sensitive unit against force applied by touch input from one or more of the hand's digits.

10. The interface as claimed in claim 1 wherein the position, shape, size, or combinations thereof of one or more of the touch-sensitive unit's activation points are adjustable.

11. The interface as claimed in claim 1 wherein the distance of the supported touch-sensitive unit from the palm of said hand is adjustable.

12. The interface as claimed in claim 1 wherein the angle of the secured touch-sensitive unit relative to said hand is adjustable.

13. The interface as claimed in claim 1 wherein the interface includes an elongated portion that acts as a counterbalance across the wrist when in associated with said hand.

14. The interface as claimed in claim 1 wherein the interface comprises a component configured to improve position stability of the interface relative to the hand is and is arranged to be gripped by at least one of the thumb or the thumb in combination with the palm of the user's hand, or the thumb in combination with the side of the palm adjacent to the thumb.

15. The interface as claimed in claim 1 one or more of the previous claims wherein one or more axes of the orientation or position of the touch-sensitive unit are mapped to a series of zones.

16. The interface as claimed in claim 1 wherein said overlay is attached to the interface by a mechanism that allows the overlay to be displaced from said touch-sensitive component and later returned to said touch-sensitive component.

17. The interface as claimed in claim 1 wherein at least one measurement of rotational motion, translational motion, orientation, or position of the touch-sensitive unit acts to modulate audio or visual outcomes controlled by another measurement of rotational motion, translational motion, orientation, or position.

18. The interface as claimed in claim 1 wherein said sensor comprises at least one of an accelerometer that measures static acceleration, an accelerometer that measures dynamic acceleration, a gyroscope that measures rotational motion, or a magnetometer that measures magnetic fields.

19. The interface as claimed in claim 1 wherein the output of said sensor modulates the outcomes controlled by the touch-sensitive unit's activation points or vice versa.

20. The interface as claimed in claim 1 wherein combined actuation of the touch-sensitive unit's activation points increases the number of distinct output events that can be produced beyond the number of activation points.
